(19) United States
(12) Patent Application Publication
(10) Pub. No.: US 2011/0262104 A1
(43) Pub. Date: Oct. 27, 2011

(54) REPRODUCTION DEVICE, REPRODUCTION METHOD, RECORDING MEDIUM, APPLICATION, AND AUTHORING DEVICE

(76) Inventors: Yuta Kiyosawa, Hiroshima (JP); Yasuyuki Matsuura, Hiroshima (JP); Tomohiro Matsumoto, Osaka (JP); Taiji Sasaki, Osaka (JP); Hiroshi Yahata, Osaka (JP)

(21) Appl. No.: 13/133,220

(22) PCT Filed: Mar. 10, 2010
(86) PCT No.: PCT/JP2010/001701

§ 371 Date: Jun. 7, 2011

(30) Foreign Application Priority Data
Mar. 12, 2009 (JP) 2009-059063

(51) Int. Cl. H04N 9/80; H04N 5/783

(52) U.S. Cl. 386/241; 386/343; 386/E09.011; 386/E05.052

(57) ABSTRACT

A playback device plays back a plurality of digital streams constituting a stream sequence while sequentially downloading the streams from an external resource contains time information indicating the current stream sequence playback time and state information indicating whether each stream is in a playable or non-playable state, and comprises an executor operable to execute an application corresponding to the stream sequence and a playback controller operable to control stream sequence playback. The application includes playback interval information for each stream, and specifies the subsequent stream to be played back after the current stream according to the playback interval information. When the state information of the subsequent stream is not the playable state, the playback controller performs one of a trickplay operation for extending the display duration of the current stream or a substitute video playback operation after the current stream in accordance with a request from the application.

### TECHNICAL FIELD

The present invention relates to a playback device for constructing and playing back a virtual package, and particularly concerns technology for playing back a plurality of digital streams that make up a stream sequence while sequentially downloading the streams from an external resource.

### BACKGROUND ART

A virtual package is constructed by combining digital streams recorded on a recording medium (such as a BD-ROM) and digital streams recorded on a rewritable recording medium (such as local storage). When a virtual package is constructed, the digital streams recorded on each of the above-described recording media are supplied to the playback device for playback and execution as though they were recorded in a single virtual package (see Patent Literature 1).

The content recorded on the recording medium can be expanded and updated by downloading new digital streams from an external resource (such as a web server) to the rewritable recording medium via a network.

Incidentally, a playback device capable of virtual package construction is also capable of playing back digital streams while sequentially downloading the streams from an external resource (termed streaming-like playback).

Specifically, bonus videos (a stream sequence) can, for instance, be made available through an external resource after a main feature recorded on the recording medium has been viewed. If these are stored in the form of multiple digital streams, then the playback device preemptively downloads at least the digital stream corresponding to the playback start position. Then, once playback of the digital stream has begun, streaming-like playback is realized by playing back the subsequent digital streams while sequentially downloading these streams.

Accordingly, the length of time a user must wait for the download can be reduced as playback can begin with only one portion of the bonus video having been downloaded. Also, in contrast to ordinary streaming playback, streaming-like playback is performed after downloading a digital stream of a fixed playback interval. Thus, trickplay modes such as fast-forward, rewind, and skip can be utilized.

### CITATION LIST

### Patent Literature

### Patent Literature 1

Japanese Patent Publication No. 2006-109494

### SUMMARY OF INVENTION

### Technical Problem

However, even though waiting time can be reduced and trickplay modes can be enabled through streaming-like playback functions, disadvantages are present in that time is needed for the digital streams to come to be in a playable state. Specifically, the time required to download a digital stream may be extremely long due to network congestion. Also, time is needed for recording the downloaded digital stream onto the recording medium. Further time is required for performing error-correction processes and the like, which are necessary for the digital stream to be made playable.

For these reasons, the subsequent digital stream to be played back after the current digital stream being played back by the playback device may not yet be in a playable state despite playback start time thereof having been reached.

Under such circumstances, the playback device may stop playback because no playable digital stream is present. As a result, nothing is displayed on the screen. When nothing is displayed on the screen, the user might be given the mistaken impression that playback has ended.

The above example describes a case in which a bonus video is sequentially played back while being downloaded. However, the same problems also apply to cases in which digital streams containing, for instance, subtitle or audio tracks, are sequentially downloaded from an external resource to be played back with the main feature recorded on the recording medium.

A conventional playback device as described above seems, to the user, to be behaving badly when performing streaming-like playback. Thus, a better-behaved playback device is desired.

The present invention aims to provide a playback device that performs streaming-like playback while exhibiting improved behavior.

### Solution to Problem

In order to achieve the above-stated aim, the present invention provides, as a first aspect, playback device for playing back a plurality of digital streams constituting a stream sequence while sequentially downloading the digital streams from an external resource as requested by an application, comprising: an execution unit operable to execute the application corresponding to the stream sequence; a time information storage unit that stores therein time information indicating a current playback time for the stream sequence; a state information storage unit that stores therein state information indicating whether each of the digital streams is in a playable state or in a non-playable state; and a playback control unit operable to control playback of the stream sequence, wherein the application includes playback interval information indicating a playback start time and a playback end time for each of the digital streams; and specifies a subsequent digital stream to be played back after the digital stream currently being played back according to the time information stored in the time information storage unit and the playback interval information, and when the state information stored in the state information storage unit indicates the non-playable state for the subsequent digital stream, the playback control unit performs, as requested by the application, one of a trickplay operation for extending a display duration of the digital stream currently being played back and playback of a substitute video as a replacement for the subsequent digital stream.

### Effects of Invention

According to above-described solution to the problem, the application is able to specify the subsequent stream to be played back after the current stream.

Given that the application is able to specify the subsequent stream, the playback control unit can control playback as requested by the application so as to avoid stopping playback when the state information of the subsequent stream indicates the non-playable state. Specifically, one of a trickplay operation for extending the display duration of the current digital stream and a substitute video playback operation after the current digital stream may be performed.

Accordingly, more time can be allowed for the subsequent digital stream to reach the playable state while something remains displayed on the screen. Thus, the user will not be given a mistaken impression that playback is over and the probability of playback stoppage can be reduced.

User-friendliness is, in turn, improved as the time needed for downloading before streaming-like playback begins is reduced, as is the probability of playback stoppage due to the subsequent digital stream not being in a playable state.

Also, in another aspect, the present invention may further comprise a playback speed storage unit that stores therein a value indicating a playback speed for the stream sequence, wherein the application specifies a playback direction for the stream sequence according to whether the value indicating the playback speed is positive or negative, and the subsequent digital stream is specified with further reference to the playback direction.

Such a playback device is able to specify the subsequent digital stream to be played back irrespective of the stream sequence playback direction. Thus, controls for avoiding playback stoppage can also be employed irrespective of the stream sequence playback direction.

Alternatively, in another aspect, the present invention may further comprise a download unit operable to sequentially download the digital streams from the external resource, wherein the state information for the subsequent digital stream is stored in the state information storage unit as non-playable when the subsequent digital stream has not yet been downloaded, and the download unit prioritarily downloads the subsequent digital stream as requested by the application.

Such a playback device is able prioritarily download the subsequent digital stream if that stream has not yet been fully downloaded. Thus, the probability that the state information of the subsequent digital stream will reach the playable state before playback proceeds to that digital stream can be increased.

Alternatively, in another aspect of the present invention, the stream sequence is played back according to a playlist, the playlist includes a plurality of play items, the play items are in one-to-one correspondence with the digital streams, each indicating a playback interval for the corresponding digital stream, a subset of the play items feature a chapter mark, and the application further includes chapter mark information indicating the subset of the play items that features the chapter mark, and specifies the digital stream corresponding to a chapter mark-featuring play item nearest to the digital stream currently being played back as the subsequent digital stream according to the chapter mark information.

Further, in another aspect of the present invention, the download unit prioritarily downloads digital streams not yet downloaded corresponding to chapter mark-featuring play items, as requested by the application.

According to such a playback device, digital streams corresponding to play items featuring chapter marks can be specified and preferentially downloaded. Thus, streaming-like playback can be realized while pausing as little as possible, even if a chapter skip instruction is received from the user.

Also, in another aspect of the present invention, the digital streams corresponding to the chapter mark-featuring play items are smaller in size than non-chapter-mark-featuring digital streams.

According to such a playback device, the digital streams corresponding to play items featuring chapter marks are smaller than other digital streams. Thus, if a chapter skip instruction is issued through a user operation during playback, the time required for downloading for which the user must wait can be reduced even if the skip destination digital stream is not yet fully downloaded.

Alternatively, in another aspect of the present invention, the state information indicates that the digital stream corresponding to a playback start position for the stream sequence is in the playable state, the application calculates (i) a playback duration from the playback start position through a digital stream immediately preceding a given digital stream not yet fully downloaded for which the state information indicates the non-playable state, and (ii) a total download time needed to download all of the digital streams from a leading digital stream up to and including the given digital stream, and the playback control unit begins playback from the playback start position as requested by the application when the total download time is less than the playback time.

According to such a playback device, playback begins when the total download time is less than the playback duration for a given digital stream with state information indicating the non-playable state. Thus, the probability that the BD-J application will issue an instruction to pause playback immediately after beginning can be reduced.

Also, in another aspect of the present invention, the application calculates the playback duration and the total download time for each of the digital streams not yet fully downloaded for which the state information indicates the non-playable state, and the playback control unit begins playback when the total download time is less than the playback time, for all of the digital streams.

According to such a playback device, playback begins when the total download time is less than the playback time, for each of the digital streams with state information indicating the non-playable state. Thus, the probability that the BD-J application will issue an instruction to pause playback immediately after beginning can be reduced.

Alternatively, in another aspect of the present invention, the playback device plays back a plurality of sub-stream sequences while downloading the sub-stream sequences from the external resource together with the stream sequence, the stream sequence is a main clip, each sub-stream sequence is a sub-clip comprising a plurality of sub-digital streams, the sub-clips include at least one of subtitle streams and audio streams, the state information further indicates whether each of the sub-digital streams is in the playable state or in the non-playable state, and during playback of one of the sub-digital streams from a given sub-clip together with the main clip, the playback control unit causes playback to continue with a sub-digital stream from another sub-clip after playing back the given sub-digital stream as requested by the application when the state information of a subsequent sub-digital stream to be played back after the sub-digital stream indicates the non-playable state and the state information of the sub-digital stream from the other sub-clip indicates the playable state.

According to such a playback device, when the state information of the subsequent sub-digital stream indicates the non-playable state and the state information of the sub-digital stream from another sub-clip indicates the playable state, playback continues with the sub-digital from the other sub-clip stream after playing back the given sub-digital stream. Thus, playback can continue without pausing even if the subsequent sub-digital stream is not in the playable state.

Alternatively, in another aspect of the present invention, the playback device plays back a plurality of sub-stream sequences while downloading the sub-stream sequences from the external resource together with the stream sequence, the stream sequence is a main clip, each of the sub-stream sequences is a sub-clip comprising a plurality of sub-digital streams, the sub-clips include at least one of subtitle streams and audio streams, the state information further indicates whether each of the sub-digital streams is in the playable state or in the non-playable state, and during playback of one of the sub-digital stream from a given sub-clip together with the main clip, the playback control unit performs the trickplay operation for extending the display duration of the digital stream and the sub-digital stream currently being played back, as requested by the application, when a user instruction is received to change from the given sub-clip to another sub-clip and the state information of the sub-digital stream to be played back from the other sub-clip indicates the non-playable state.

According to such a playback device, when a user instruction is received to change the sub-clip and the state information of the destination sub-digital stream indicates the non-playable state, the playback controller performs controls for avoiding playback stoppage. Thus, the probability of playback stoppage can be reduced.

### BRIEF DESCRIPTION OF DRAWINGS

FIG. 1 is a diagram showing a usage example of a playback device 100.

FIG. 2 is a diagram showing an example of a playlist.

FIG. 3 is a diagram showing a specific example of the playlist.

FIG. 4 is a diagram illustrating the manner in which audiovisual clips are downloaded.

FIG. 5 is a diagram showing a sample configuration for the playback device 100.

FIG. 6 shows a correspondence table for clip numbers and state information.

FIG. 7 shows a list of system parameters (SPRM).

FIG. 8 is a block diagram showing the functional structure of a BD-J application.

FIG. 9 is a diagram illustrating the relationship between network playback information and the playlist.

FIG. 10 is a schematic diagram of streaming-like playback.

FIG. 11 is a diagram illustrating playback start timing.

FIG. 12 is a flowchart showing the processing order for the BD-J application.

FIG. 13 is a flowchart showing the processing order for a playlist playback start time process.

FIG. 14 is a flowchart showing the processing order for a priority download process.

FIG. 15 is a flowchart showing the processing order for a priority list creation process.

FIG. 16 is a flowchart showing the processing order for a playback state monitoring process.

FIG. 17 is a flowchart showing the processing order for a play item specification process.

FIG. 18 is a flowchart showing the processing order for a playlist playback process.

FIG. 19 is a diagram illustrating the playback controls by the BD-J application when a subsequent audiovisual clip to be played back is not in an Enabled state.

FIG. 20 is a flowchart showing the processing order for the priority list creation process for Variation 1-2.

FIG. 21 is a diagram illustrating the manner in which time needed to download audiovisual clips referenced by play items featuring chapter marks is reduced.

FIG. 22 shows a specific example of the playlist pertaining to Embodiment 2.

FIG. 23 is a schematic diagram of streaming-like playback involving sub-play items.

FIG. 24 is a flowchart showing the processing order for the priority download process pertaining to Embodiment 2.

FIG. 25 is a flowchart showing the processing order for the playback state monitoring process pertaining to Embodiment 2.

FIG. 26 is a flowchart showing the processing order for the playlist playback process pertaining to Embodiment 2.

FIG. 27 is a diagram illustrating a scenario in which a subtitle track change is requested by the user such that the current playback position is changed over from a file “10003.m2ts” referenced by sub-play item #3 from a sub-path with ID=0 to a file “20003.m2ts” referenced by sub-play item #3 from a sub-path with ID=1.

FIG. 28 is a flowchart showing the processing order of the playback state monitoring process for sub-path changes.

FIG. 29 is a diagram illustrating playback control in a situation where an audiovisual clip referenced by the subsequent sub-play item to be played back is not in the Enabled state.

FIG. 30 is a flowchart showing the processing order of the playback state monitoring process pertaining to Variation 2-2.

FIG. 31 is a configuration diagram of an authoring system.

FIG. 32A is a flowchart showing the processing order for ROM disc image creation, and FIG. 32B is a flowchart showing the processing order for update kit image creation.

FIG. 33 is a diagram showing a sample audiovisual clip structure.

FIG. 34 is a schematic diagram illustrating the manner in which audiovisual clips are multiplexed.

FIG. 35 is a diagram illustrating the manner in which a video stream is contained within a PES packet stream.

FIG. 36 is a diagram showing the format of the TS packets as ultimately written into the audiovisual clips.

FIG. 37 is a diagram showing a PMT data structure.

FIG. 38 is a diagram showing a sample a clip information file.

FIG. 39 is a diagram showing sample stream property information.

FIG. 40 is a diagram showing a sample entry map.

FIG. 41 is a diagram showing a sample data structure for playlist information.

FIG. 42 is a diagram showing the internal structure of sub-path information.

FIG. 43 is a diagram showing a sample overall configuration of an STN_table.

FIG. 44 is a diagram showing a sample internal configuration of a system target decoder 104.

FIG. 45 is a diagram showing a sample BD-ROM structure.

FIG. 46 is a diagram showing a sample internal structure for an index file.

FIG. 47 is a diagram illustrating a movie object.

FIG. 48 is a diagram showing a sample internal structure of the update kit stored in the local storage 300.

FIG. 49 is a diagram showing a sample virtual package constructed from merge management information file content and from files on the BD-ROM and in the update kit on which that content is based.

FIG. 50 is a diagram showing sample network playback information.

### DESCRIPTION OF EMBODIMENTS

The Embodiments of the present invention are described below with reference to the drawings.

### Embodiment 1

### Overall Configuration

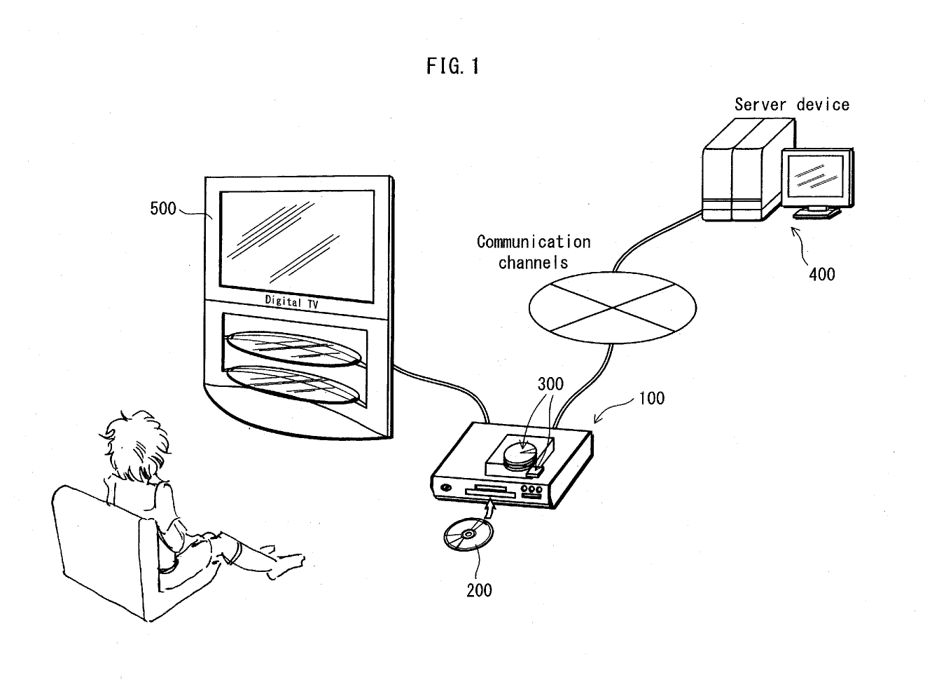

First, a playback device is described through a practical usage example. FIG. 1 shows a playback device 100 as a usage example of the present Embodiment. As shown, the playback device 100 is used in conjunction with a BD-ROM 200, local storage 300, a web server 400, and a television 500.

The playback device 100 and the television 500 form a home theatre system for playing back the BD-ROM 200. The playback device is also capable of writing downloaded data to a recording medium, thus also serving as a recording device.

The BD-ROM 200 is a recording medium on which is recorded a movie or similar content.

Local storage 300 is loaded into the playback device 100 and used as a receptacle for content distributed by the movie distributor's web server 400. Thus, content can be downloaded via the Internet and stored in local storage to expand or update the content recorded on the BD-ROM 200.

The web server 400 is a server device running an official site for a movie distributor, for example. File sets (update kits) that realize partial overwrites and additions to the movie content recorded on the BD-ROM 200 are supplied by the web server 400 via the Internet and similar means.

The television 500 displays the movie being played back and supplies an interactive control environment to a user by displaying menus and the like.

This concludes the description of the playback device usage example. Next, a playlist is described as the object of playback by the playback device.

### (Playlist)

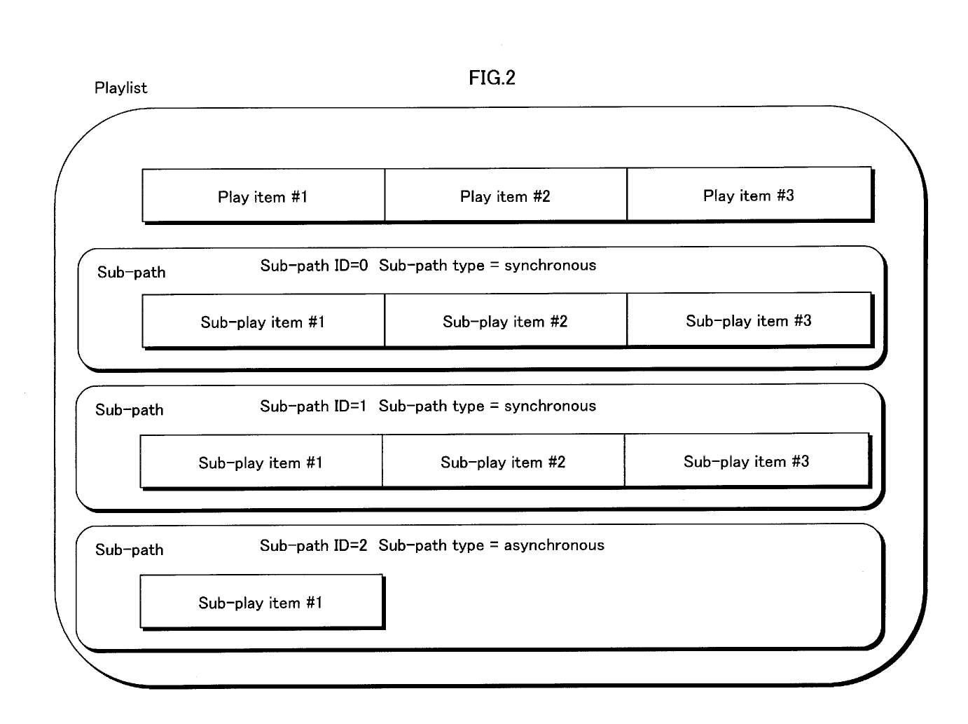

FIG. 2 shows an example of a playlist. A playlist comprises a main path and one or more sub-paths.

The main path comprises one or more play items.

The play items include a stream number table.

The stream number table indicates the stream numbers of elementary streams that may be played back for the play items.

The sub-paths indicate playback path sequences that are played back at the same time as the main path. Each sequence comprises one or more sub-play items. IDs (sub-path IDs) are assigned to the sub-paths in playlist registration order. The sub-path IDs are used to identify the sub-paths. Furthermore, a sub-path type is indicated, which may be either synchronous or asynchronous. Synchronous sub-paths are played back concurrently with the main path, while asynchronous sub-paths are not.

In synchronous sub-paths, the playback start and playback end timestamps of the sub-play items are given according to the same chronological axis as those of the main path. However, in asynchronous sub-paths, these timestamps are given according to a different chronological axis than the main path.

The details of the playlist information, play item information, stream number tables, and sub-play item information will be described later.

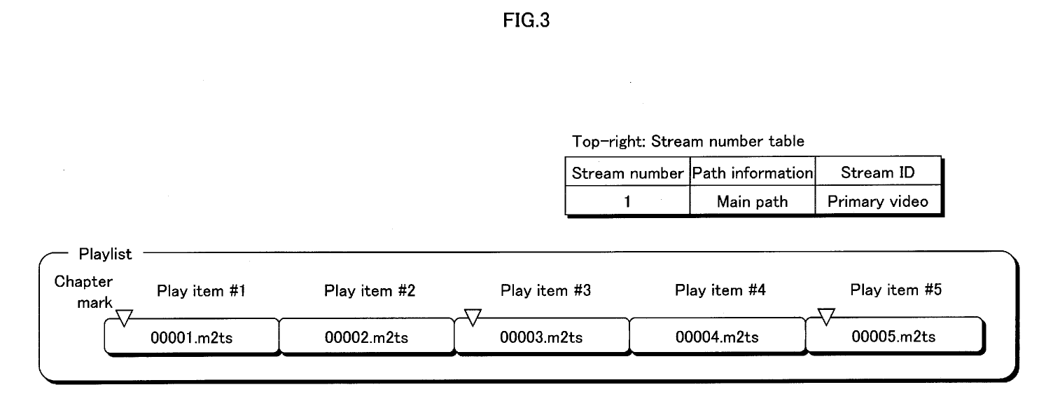

FIG. 3 shows a specific example of a playlist. The playlist shown comprises a main path that includes five play items, #1, #2, #3, #4, and #5. These five play items respectively reference the files “00001.m2ts”, “00002.m2ts”, “00003.m2ts”, “00004.m2ts”, and “00005.m2ts”. That is, there is a one-to-one relationship between the play items and the audiovisual clips.

The audiovisual clips referenced by the play items all consist of content from the update kit stored in local storage, and have network attributes assigned thereto. Given the network attributes, storing the audiovisual clips referenced by play items during playlist playback in local storage immediately before a given play item becomes current suffices for playback. There is no need to store all of the audiovisual clips that comprise a single piece of content in local storage ahead of time.

Each of the main path play items has a stream number table such as that shown in the upper-right corner of FIG. 3. The stream number table shown holds an entry that has been assigned the stream number 1. This entry permits the playback of a primary video stream referenced by the main path play item information.

The operations of the playback device pertaining to the present Embodiment are described below with reference to the specific playlist example shown in FIG. 3. This playlist, as an example, corresponds to bonus video content distributed by the web server 400 after the user has viewed the movie recorded on the BD-ROM 200.

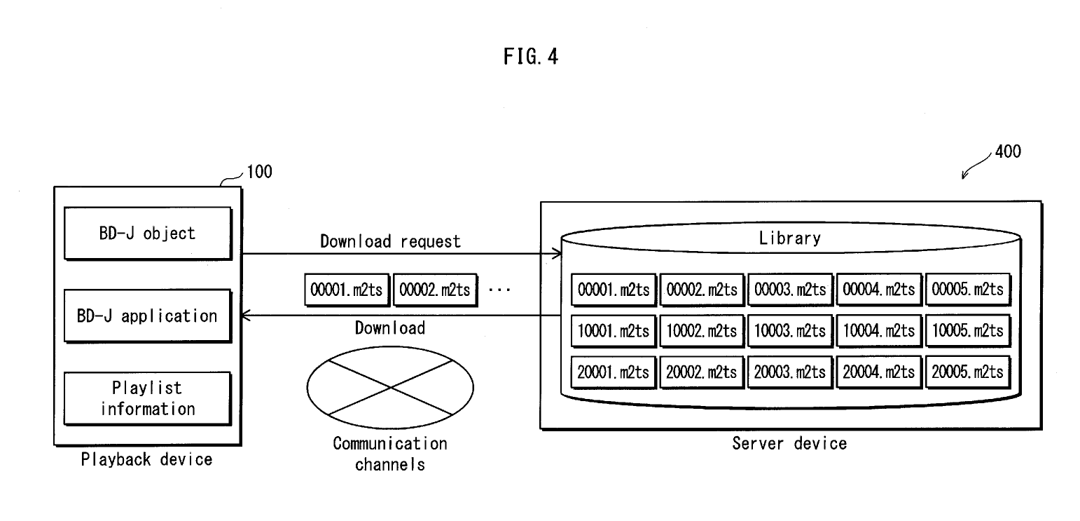

FIG. 4 illustrates the manner in which audiovisual clips are downloaded. The web server 400 is shown on the right-hand side and the playback device 100 is shown on the left-hand side. Communication channels, such as the Internet or an intranet, are shown in the middle.

The files “00001.m2ts”, “00002.m2ts”, “00003.m2ts”, “00004.m2ts”, and “00005.m2ts” are on the web server 400. The playback device 100 sequentially transmits a download request to the web server 400 for each of the files, and can thus download the files therefrom.

The components used by the playback device 100 for making download requests, downloading, and playing back playlists are described below. A BD-J application and a BD-J object are recorded on the BD-ROM 200 as components for performing these processes. The details of these components are described below.

### (BD-J Application)

The BD-J application is a Java™ application that runs according to application signaling that takes each title as defining a lifecycle. The application runs on a platform that fully implements the Java 2 Micro Edition (J2ME) Personal Basis Profile (PBP 1.0) and the Globally Executable MHP specification (GEM1.0.2) for package media targets.

The BD-J application initiates playlist playback by instructing a Java™ virtual machine to generate a JMF (Java Media Framework) player instance for the purpose of playback. A JMF player instance is actual data generated in the virtual machine heap memory in accordance with the JMF player class.

Once the JMF instance is generated, the BD-J application makes a request to the web server 400 to download the audiovisual clips needed to play back the playlist.

The BD-J application uses a GUI framework to receive user operations prior to playing back the playlist or downloading audiovisual clips as described above. The GUI framework used by the Java™ application includes the HAVi framework and the remote control navigation structure defined in GEM 1.0.2.

Thus, the Java™ application displays buttons, text, and online content (such as that of a BBS) in accordance with the HAVi framework. As such, a screen display can be realized in combination with movie display. Accordingly, playlist playback and audiovisual clip downloads can be realized as described above by using a remote control. The group of files comprising the BD-J application can be converted to a Java™ archive file according to the specifications found at http://java.sun.com/j2se/1.4.2/docs/guide/jar/jar.html. A Java™ archive file is a specialized version of the .zip file format. The content of such files can be verified with any .zip file expansion software on the market.

In addition, the BD-J application code includes functional API calls and can thereby execute functions exclusive to the playback device 100.

### (BD-J Object)

The BD-J object includes an application management table (ApplicationManagementTable( )). This table consists of data executed on the platform in application signaling, which accompanies title switching during BD-ROM playback. Specifically, “ApplicationManagementTable( )” includes an “application_id” field that indicates the application to be executed and an “application_control_code” field that indicates the control code used to start the BD-J application.

The “application_control_code” field specifies the initial state of execution for the application after title selection. This field may be set to either AUTOSTART or to PRESENT. If set to AUTOSTART, then the BD-J application is automatically loaded and started by the virtual machine, whereas if the code is set to PRESENT, the BD-J application is loaded but not automatically started.

Next, the interior configuration of the playback device 100 is described.

### (Playback Device)

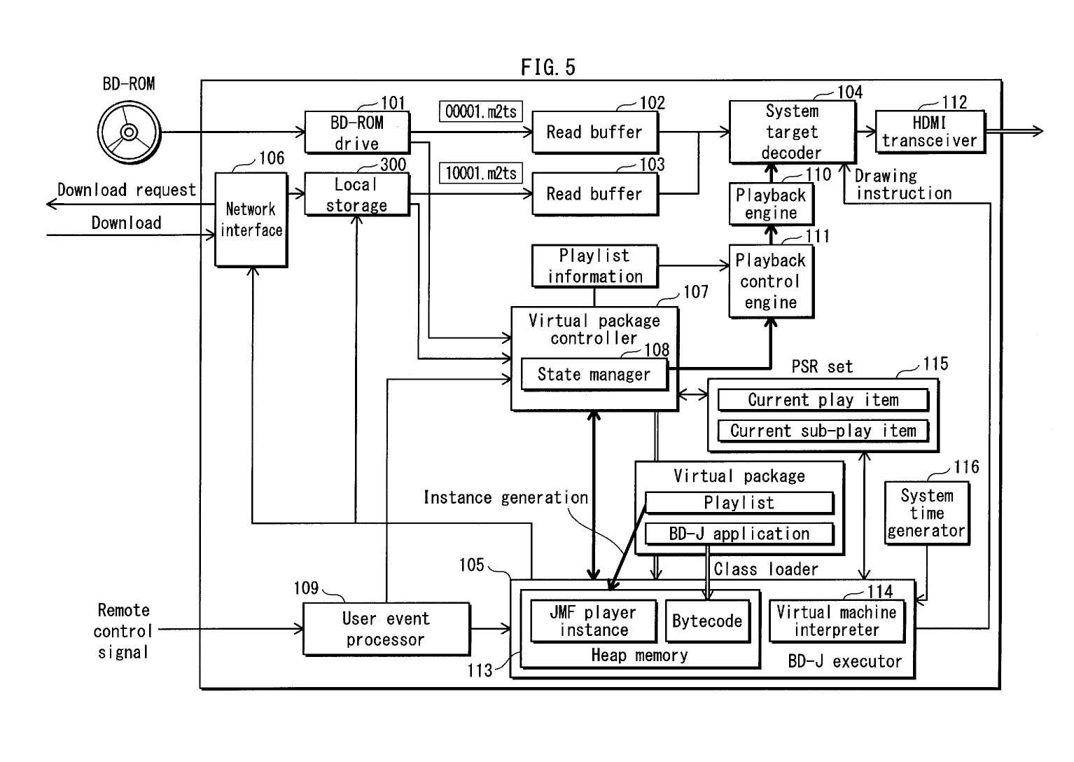

FIG. 5 shows a sample configuration for the playback device 100. The playback device 100 comprises a BD-ROM drive 101, a read buffer 102, a read buffer 103, a system target decoder 104, a BD-J executor 105, a network interface 106, a virtual package controller 107, a state manager 108, a user event processor 109, a playback engine 110, a playback control engine 111, an HDMI transceiver 112, a heap memory 113, a virtual machine interpreter 114, and a PSR set 115. The details of these components are described below.

(BD-ROM Drive 101)

The BD-ROM drive 101 reads data from a BD-ROM disc and stores the data in the read buffer 102.

(Read Buffer 102)

The read buffer 102 is a memory buffer or the like that temporarily stores therein the data read by the BD-ROM drive 101.

(Read Buffer 103)

The read buffer 103 is a memory buffer or the like that temporarily stores therein the data read from local storage.

(System Target Decoder 104)

The system target decoder 104 demultiplexes the source packets read from the read buffers 102 and 103, and also decodes the streams obtained as a result of demultiplexing for playback.

In addition, the system target decoder 104 decodes and plays back graphical data, such as JPEG and PNG files, transferred thereto by the BD-J executor 105 for displaying menus and the like. The details of the system target decoder 104 are described later.

(BD-J Executor 105)

The BD-J executor 105 is a program processing engine that executes the BD-J application transferred thereto by the virtual package controller 107. The BD-J executor 105 performs the following controls in accordance with the programming of the BD-J application.

(1) Performing playlist playback start, priority download, and playback state monitoring processes via the virtual package controller 107. These processes are later described in detail. (2) Obtaining update kits from the web server on the Internet, and storing the kits in local storage. (3) Ordering the construction of a virtual package, in which the content of the BD-ROM and the update kits is merged. (4) Setting values for player variables. (5) Transferring PNG or JPEG files used for menu and game graphics to the system target decoder 104, and displaying the files on the screen. The above controls can be performed freely, in response to program specifics. At authoring time, the BD-J application programming step determines how the controls are to be operated.

(Network Interface 106)

The network interface 106 fulfills communication functions for the playback device 100. Given a URL specified by the BD-J application, the network interface 106 can establish a TCP or FTP connection with a web server. Through the connection so established, the Java™ application can download content from the web.

(Virtual Package Controller 107)

The virtual package controller 107 controls the BD-ROM drive 101 and local storage 300, constructs virtual packages, and controls the playback performed by the playback device 100. The virtual package merges the content recorded on the BD-ROM disc with difference data stored in local storage 300 according to merge management information, also stored in local storage 300, as a virtual BD-ROM package. The virtual package so constructed shares the structure of the BD-ROM. The virtual package may be constructed when the disc is inserted, or else when a virtual package construction instruction is issued by the BD-J executor 105.

After the virtual package has been constructed, the virtual package controller 107 controls the playback of audiovisual clips via the playlist information according to playback instructions from the BD-J executor 105 and notifications from the user event processor 109. Also, the virtual package controller 107 sets and references player variables to perform playback.

(State Manager 108)

The state manager 108 manages the state information of individual audiovisual clips on the BD-ROM and in local storage through associations with the clip number of each clip. The state information indicates whether the state of a given clip is Missing, Enabled, or Disabled.

The Missing state signifies that an audiovisual clip referenced by play item or sub-play item information is not present on the BD-ROM nor in local storage. This means that the download has not been completed and that playback is impossible.

The Enabled state signifies that the clip is ready for playback by the virtual package controller 107. This state is controlled by the BD-J application API. When an Enabled-state-setting API is executed, the target audiovisual clip is put into read-only mode and the virtual package controller 107 is able to play back the clip.

The Disabled state is the opposite of the Enabled state, and signifies that the virtual package controller 107 is not allowed to play back a given audiovisual clip. Audiovisual clips that have never been set to the Enabled state by the BD-J application are in the Disabled state. Furthermore, audiovisual clips in the Enabled state cannot be deleted or overwritten until the BD-J application changes such clips to the Disabled state via an API.

Taken together, audiovisual clips in the Missing state and in the Disabled state are said to be Unavailable clips, being in an Unavailable state.

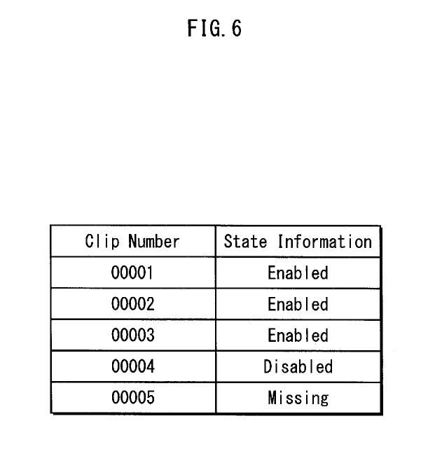

FIG. 6 is a table showing the correspondence between the clip numbers and the state information. In the example shown, each of the files “00001.m2ts”, “00002.m2ts”, and “00003.m2ts” corresponding to clip numbers 00001, 00002, and 00003 are in the Enabled state, the file “00004.m2ts” corresponding to clip number 00004 is in the Disabled state, and the file “00005.m2ts” corresponding to clip number 00005 is in the Missing state. This correspondence table is over-written by the BD-J application whenever appropriate, in accordance with the download state of the audiovisual clips and so on.

Upon receiving an audiovisual clip state information request from the BD-J application, the state manager 108 references the correspondence table and returns the state information for the relevant audiovisual clip.

(User Event Processor 109)

The user event processor 109 makes process execution requests to the BD-J executor 105 and to the virtual package controller 107 in response to user operations made through a remote control. For example, when the user presses a button on the remote control, the user event processor 109 makes a request for the BD-J executor 105 to execute the playlist corresponding to the button so pressed. As another example, when the user presses the fast-forward or rewind buttons, the user event processor 109 instructs the virtual package controller 107 to fast-forward or rewind the corresponding audiovisual clip in the playlist currently being played back.

(Playback Engine 110)

The playback engine 110 executes audiovisual playback functions. The audiovisual playback functions of the playback device are a group of traditional functions inherited from DVD players and CD players, namely Play, Stop, Pause On, Pause Off, Still Off, Forward Play (at designated speed), Backward Play (at designated speed), Audio Change, Subtitle Change (or Secondary Video Change), and Angle Change. The playback engine 110, which realizes the preceding functions, controls the system target decoder 104 such that the portions of the audiovisual clips at the desired timestamp are decoded.

(Playback Control Engine 111)

The playback control engine 111 executes playback control functions on the playlist. The playback control functions are a subset of the playback functions performed by the playback engine 110, namely Play and Stop. These functions are performed according to the current playlist information and clip information.

(HDMI Transceiver 112)

The HDMI transceiver 112 receives device information from other devices, which are connected by HDMI (HDMI: High Definition Multimedia Interface). The HDMI transceiver 112 also transmits uncompressed digital video obtained through decoding by the system target decoder along with LPCM audio data or compression-coded audio data to other devices connected by HDMI.

(Heap Memory 113)

The heap memory 113 is stack memory reserved for the BD-J executor 105 in which are stored JMF player instances generated by the BD-J application, bytecode generated by running the class loader corresponding to the BD-J application, and the like. These are supplied to the virtual machine interpreter 114 for execution in threaded form, following the First In, First Out system.

(Virtual Machine Interpreter 114)

The virtual machine interpreter 114 converts the bytecode stored in heap memory 113 into CPU-executable native code, and then has the CPU execute the code so converted.

(PSR Set 115)

The PSR set 115 is a set of player setting registers and player status registers in which player variables are stored. The player variables include system parameters (SPRM), which indicate player status, and general parameters (GPRM), which are used for general purposes.

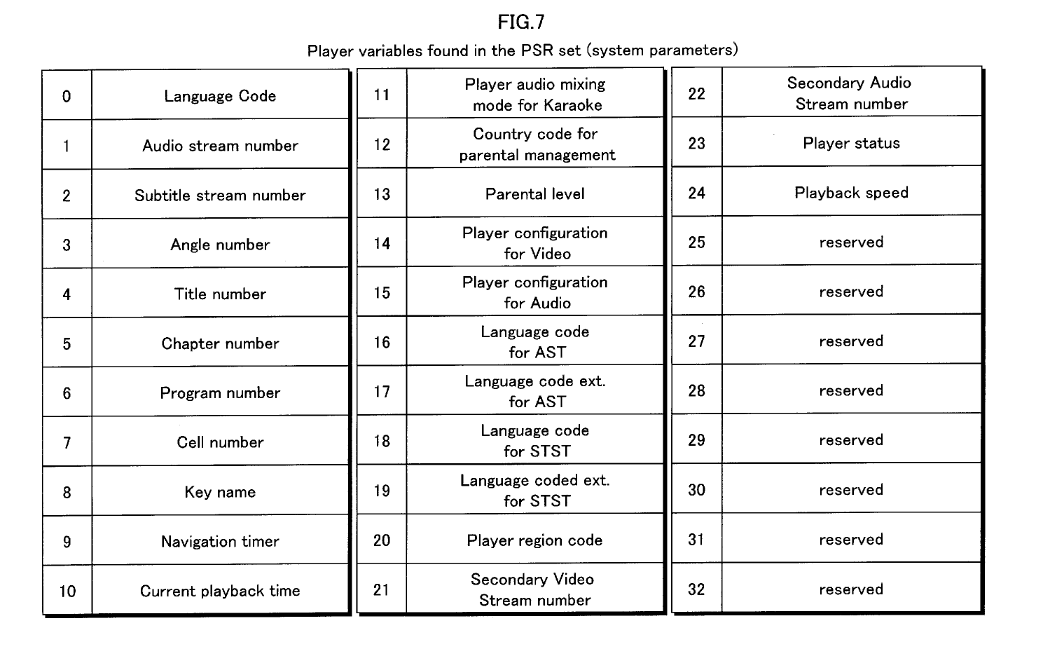

FIG. 7 is a list of system parameters (SPRM).

SPRM (0): Language code

SPRM (1): Primary audio stream number

SPRM (2): Subtitle stream number

SPRM (3): Angle number

SPRM (4): Title number

SPRM (5): Chapter number

SPRM (6): Program number

SPRM (7): Cell number

SPRM (8): Key name

SPRM (9): Navigation timer

SPRM (10): Current playback timestamp

SPRM (11): Karaoke audio mixing mode

SPRM (12): Parental management country code

SPRM (13): Parental level

SPRM (14): Player configuration (video)

SPRM (15): Player configuration (audio)

SPRM (16): Audio stream language code

SPRM (17): Audio stream language code (extension)

SPRM (18): Subtitle stream language code

SPRM (19): Subtitle stream language code (extension)

SPRM (20): Player region code

SPRM (21): Secondary video stream number

SPRM (22): Secondary audio stream number

SPRM (23): Player status

SPRM (24): Playback speed

SPRM (25): reserved

SPRM (26): reserved

SPRM (27): reserved

SPRM (28): reserved

SPRM (29): reserved

SPRM (30): reserved

SPRM (31): reserved

SPRM (10) is updated as picture data belonging to the audiovisual clip are displayed. Specifically, when the playback device displays new picture data, SPRM (10) is updated with the value indicated by the presentation time stamp (PTS) of the new data so displayed. The current playback time can thus be obtained by referencing SPRM (10).

The SPRM (16) audio stream language code and the SPRM (18) subtitle stream language code can be set through the player OSD or similar. These codes indicate the default language code of the player. For example, if the SPRM (16) audio stream language code set to English, then when a playlist is played back, the BD-J application on the BD-ROM disc can be given a function such that the application seeks out stream entries in the play item stream selection table with the same language code and selects such audio streams for playback. Each of the SPRMs is contained in a 32-bit word length register. The SPRM-specifying numbers written in brackets are, in essence, the register number of the corresponding register (however, this does not hold for SPRM (21) and SPRM (22)).

(System Time Generator 116)

A system time generator 116 generates system time information indicating the time elapsed since system startup and supplies the information so generated to the BD-J executor 105.

The components of the BD-J application are described next.

### (BD-J Application Components)

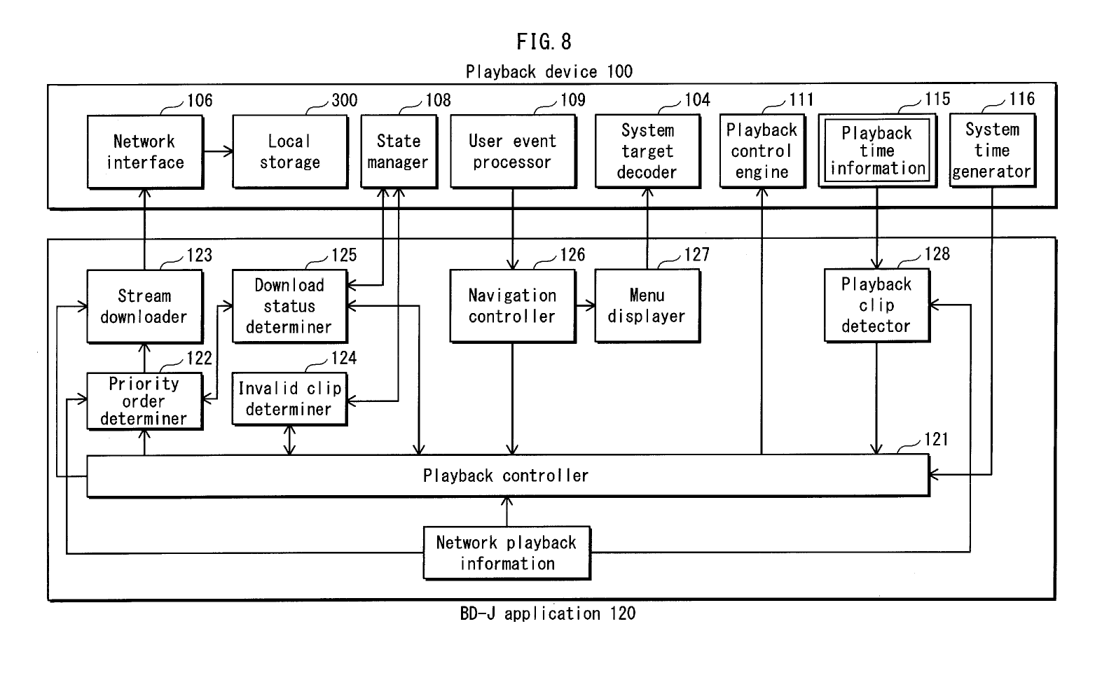

FIG. 8 is a block diagram showing the components of the BD-J application. As shown, the BD-J application comprises a playback controller 121, a priority order determiner 122, a stream downloader 123, an invalid clip determiner 124, a download status determiner 125, a navigation controller 126, a menu displayer 127, and a playback clip detector 128.

(Playback Controller 121)

The playback controller 121 performs the following processes. (i) Receiving notifications from the playback clip detector 128 regarding the subsequent clip to be played back after the current clip, and requesting a determination from the invalid clip determiner 124 regarding whether the subsequent clip is in a playable state or in a non-playable state. (ii) Receiving determination results from the invalid clip determiner 124 regarding whether the subsequent clip is in a playable state or in a non-playable state, and controlling the playback control engine 111 according to the determination results so received. (iii) Receiving current clip notifications and playback speeds from the playback clip detector 128, and requesting determinations from the priority order determiner 122 regarding priority order for downloading clips in the event that the state information indicates that a clip is in a non-playable state, not having been fully downloaded. When making such a request, the playback controller 121 also notifies the priority order determiner 122 of the clip number and playback speed for the audiovisual clip currently being played back. (iv) Obtaining the system time from the system time generator 116, and obtaining the clip numbers of fully-downloaded audiovisual clips from the download status determiner 125. The playback controller 121 then instructs the playback control engine 111 to begin playback of the playlist according to the system time, the clip numbers, and the network playback information.

(Priority Order Determiner 122)

The priority order determiner 122 creates a priority list indicating which audiovisual clips are to be prioritized for download. This list is created according to the network playback information, the current clip number, the playback speed, and the clip numbers of clips not yet fully downloaded.

(Stream Downloader 123)

The stream downloader 123 instructs the network interface 106 to download audiovisual clips that have not yet been fully downloaded according to the priority list.

(Invalid Clip Determiner 124)

The invalid clip determiner 124 requests the state information for the subsequent clip from the state manager 108. The invalid clip determiner 124 notifies the playback controller 121 of whether the next clip is in a playable state or in a non-playable state based on this state information.

(Download Status Determiner 125)

The download status determiner 125 requests the state information of each clip in the current playlist from the state manager 108. The download status determiner 125 then determines whether or not the audiovisual clips corresponding to this state information have been fully downloaded and notifies the playback controller 121 of the clip numbers corresponding to clips accordingly deemed fully downloaded. The download status determiner 125 also notifies the priority order determiner 122 of the clip numbers corresponding to clips deemed not yet fully downloaded.

(Navigation Controller 126)

The navigation controller 126 controls the menu displayer 127 and the playback controller 121 in response to user operations. For example, if the user operation is a playlist and play item selection, then the navigation controller 126 instructs the playback controller 121 to play back the audiovisual clip referenced by the selected playlist play item.

(Menu Displayer 127)

The menu displayer 127 transfers PNG and JPEG files used for menu and game graphics to the system target decoder 104 to display these files on the screen.

(Playback Clip Detector 128)

The playback clip detector 128 obtains the current playback time from the PSR set 115, and then specifies the current playback clip by cross-referencing the playback time so obtained and the network playback information. The playback clip detector 128 also obtains the playback speed from the PSR set 115 and specifies the playback direction according to whether the playback speed is positive or negative. Then, the playback clip detector 128 specifies the subsequent clip to be played back after the current clip according to the playback direction so specified and the network playback information.

### (Network Playback Information)

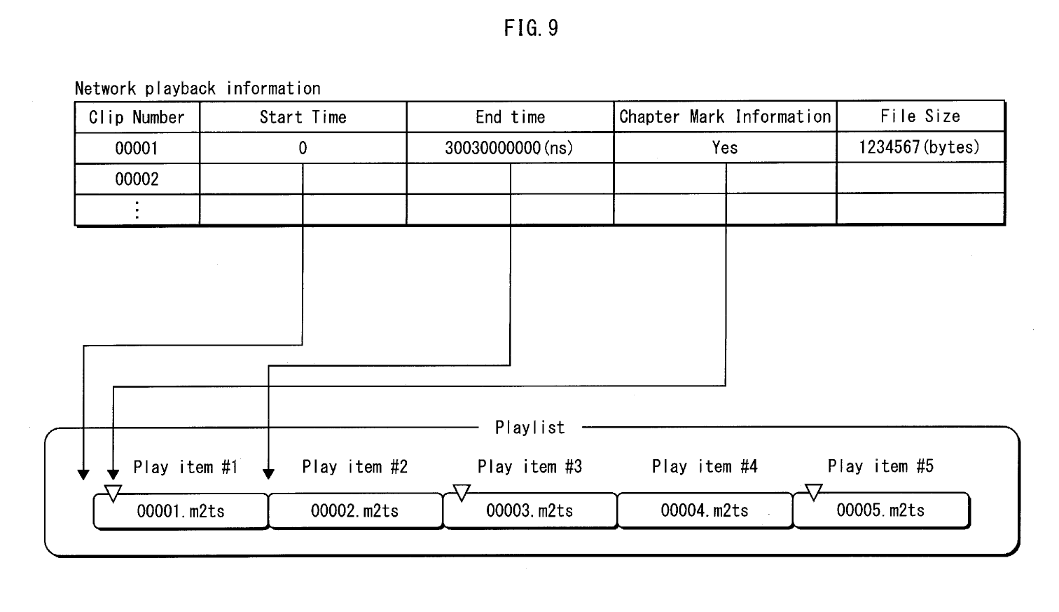

Next, the relationship between the network playback information and the playlist shown in FIG. 3 is described with reference to FIG. 9. As shown in FIG. 9, the network playback information includes clip numbers, start times, end times, chapter mark information, and file sizes. The number of each of these is equal to the number of play items in the playlist shown in FIG. 3. Specifically, there is a one-to-one relationship between the play items and the rows of information within the network playback information shown in FIG. 9.

The clip numbers correspond to the file names of the audiovisual clips referenced by each play item, indicating the same values.

The start times correspond to the playback start timestamps for each play item, indicating the same values.

The end times correspond to the playback end timestamps for each play item, indicating the same values.

The chapter mark information indicates whether or not the corresponding play item features a chapter mark.

The file sizes indicate the file size of the audiovisual clip referenced by each play item.

The BD-J application includes the above-described network playback information and can thus specify the current play item by cross-referencing the current playback time obtained from the playback device and the network playback information. There is a one-to-one correspondence between the play items and the audiovisual clips. This allows the BD-J application to specify the current clip according to the clip numbers included in the network playback information.

Furthermore, the BD-J application can cross-reference the playback speed obtained from the playback device and the network playback information to specify the subsequent audiovisual clip to be played back.

### Specific Example

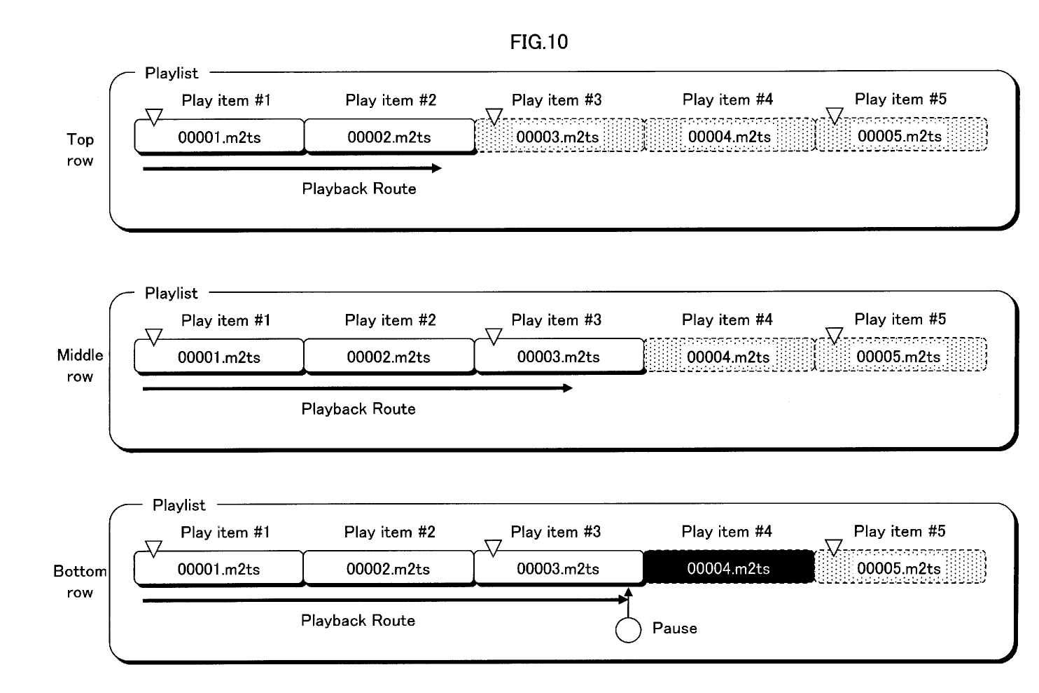

Next, the playback route of the playback control engine 111 is described in a specific example where a virtual package is used for streaming-like playback. FIG. 10 is a schematic diagram of streaming-like playback.

Streaming-like playback involves parallel playback and download of audiovisual clips referenced by play item information and sub-play item information. Network attributes are assigned to the audiovisual clips so as to allow a clip corresponding to given piece of play item information or sub-play item information to be stored in local storage just in time, immediately before the given piece of current play item or sub-play item information becomes current.

The top row of FIG. 10 shows a playlist. The playlist comprises five play items respectively referencing the files “00001.m2ts”, “0002.m2ts”, “00003.m2ts”, “00004.m2ts”, and “00005.m2ts”. All of these consist of content from the update kit stored in local storage, and each has network attributes assigned thereto. The files “00001.m2ts” and “00002.m2ts” have already been fully downloaded and set to the Enabled state by the BD-J application. The files “00003.m2ts”, “00004.m2ts”, and “00005.m2ts” either have not yet been downloaded and are thus in the Missing state, or have been downloaded but are in the Disabled state.

When the playback control engine 111 sequentially plays back the playlist beginning with the first play item, playback is not impeded as long as the playback position remains in play item #1. This is because the play item information for play items #1 and #2 references audiovisual clips in the Enabled state. The file “00003.m2ts” is not in the Enabled state. Thus, according to the state information of this file, the BD-J application might pause during play item #2.

In the top row of FIG. 10, playback has progressed through a portion of play item #2.

The middle row of FIG. 10 shows a playback position further advanced than that shown in the top row. As shown, the file “00003.m2ts” has been fully downloaded before the playback position moves into play item #3, and the file has been set to the Enabled state by the BD-J application. Accordingly, no pause occurs during play item #2, and playback moves on to play item #3.

In the middle row of FIG. 10, playback has progressed through a portion of play item #3.

The bottom row of FIG. 10 shows a playback position further advanced than that shown in the middle row. Before the playback position moves on to play item #4, the file “00004.m2ts” either has not yet been fully downloaded and is thus in the Missing state, or is in the Disabled state. As the file “00004.m2ts” is not in a playable state, the BD-J application makes an instruction to pause the playback of the file “00003.m2ts”.

Thus, the BD-J application can transmit a request to the playback control engine 111 to pause the playback of “00003.m2ts” before playback of “00004.m2ts” is attempted. During the pause, an image of some kind remains displayed on the screen.

Accordingly, playback stop caused by “00004.m2ts” not being in a playable state can be avoided.

Pausing the playback of “00003.m2ts” allows more time for “00004.m2ts” to reach the Enabled state. Playback can be resumed by unpausing once “00004.m2ts” is in the Enabled state.

As described above, a streaming-like playback method can be realized in which playback is paused rather than stopped. Specifically, there is always something being displayed on the screen.

### (Playback Start Time)

Next, the start time of playlist playback is described. Streaming-like playback can be initiated when, at minimum, the audiovisual clip corresponding to the playback start position is in the Enabled state. However, when the only clip in the Enabled state is the clip corresponding to the playback start position, the BD-J application could pause playback immediately after initialization if the subsequent clip to be played back is not in the Enabled state due to network congestion or similar conditions.

The following focuses on download time, which is heavily influenced by network congestion. A method for realizing a streaming-like playback method based on download time in which playback is paused as little as possible is described below.

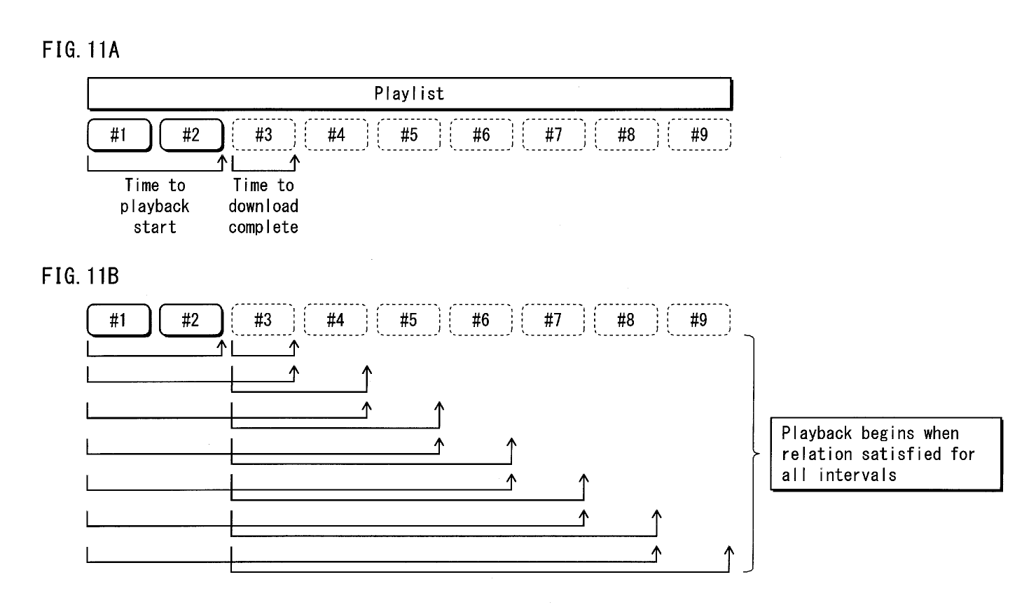

FIG. 11 is a diagram illustrating the playback start timing. FIG. 11A shows a playlist comprising nine play items, #1 through #9. Currently, the audiovisual clips corresponding to play items #1 and #2 have been fully downloaded, while the clip corresponding to the other play items have not yet been fully downloaded. In order to realize streaming-like playback without ever pausing a clip under such conditions, for all of the clips that have yet to be downloaded, the time remaining until a given clip is played back should be greater than or equal to the time required until the given clip is fully downloaded. This relation is expressed by the below-inscribed (Math. 1).

$${\sum }_{i = l}^{n - 1} {PBTime}_{i} \geq {\sum }_{j = m}^{n} {DLTime}_{j} \qquad ( Math . 1 )$$

Here, l indicates the audiovisual clip corresponding to the playback start position and m indicates the first of the audiovisual clips that have not yet been fully downloaded. n indicates a given audiovisual clip that has not yet been fully downloaded.

If (Math. 1) is satisfied for each of the audiovisual clips corresponding to play items #3 through #9, then playback of clip #1 may begin.

As clip download time fluctuates depending on the degree of network congestion, there may of course be cases in which, even though playback begins with (Math. 1) satisfied, the state information of the subsequent clip to be played back does not indicate a playable state.

Nevertheless, by using (Math. 1) as a prerequisite for initiating playback, the probability that the BD-J application will pause playback immediately after starting can be diminished.

### (BD-J Application Processing)

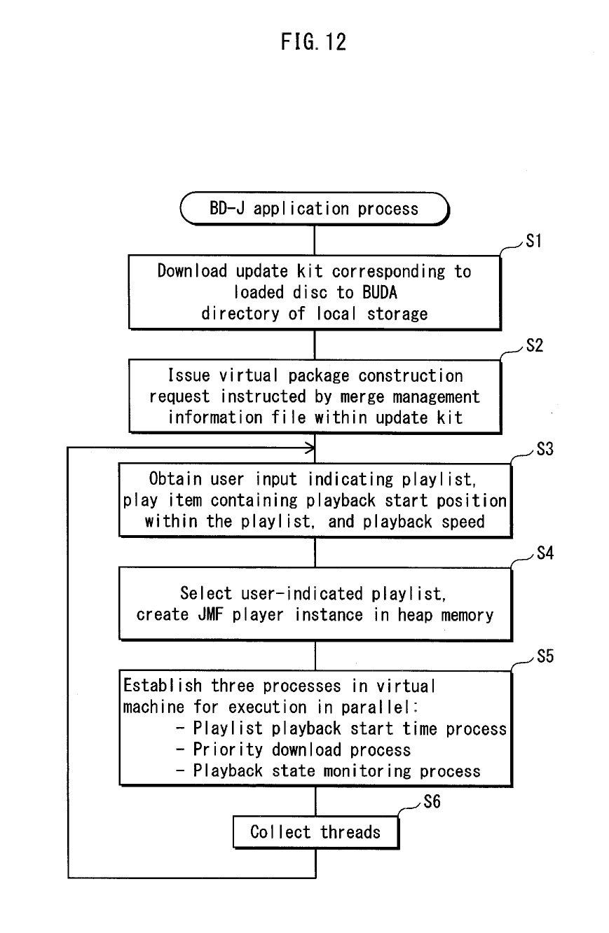

FIG. 12 is a flowchart showing the processing order for the BD-J application.

In step S1, the BD-J application downloads the update kit corresponding to the loaded BD-ROM into the local storage BUDA (Binding Unit Data Area) directory.

In step S2, the BD-J application issues a virtual package construction request as instructed by the merge management information file within the update kit.

Subsequently, steps S3 through S6 are executed in a loop. First, in step S3, user input indicating the playlist, the play item within the playlist in which the playback start position is found, and the playback speed are obtained.

Then, in step S4, the playlist corresponding to the user input is selected and a JMF player instance is created in heap memory.

In step S5, three threaded processes are established in the virtual machine and executed in parallel. These are (1) a playlist playback start time process, (2) a priority download process, and (3) a playback state monitoring process.

When the execution of these three processes is complete, the three threads of step S6 end and the process returns to step S3.

### (Playlist Playback Start Time Process)

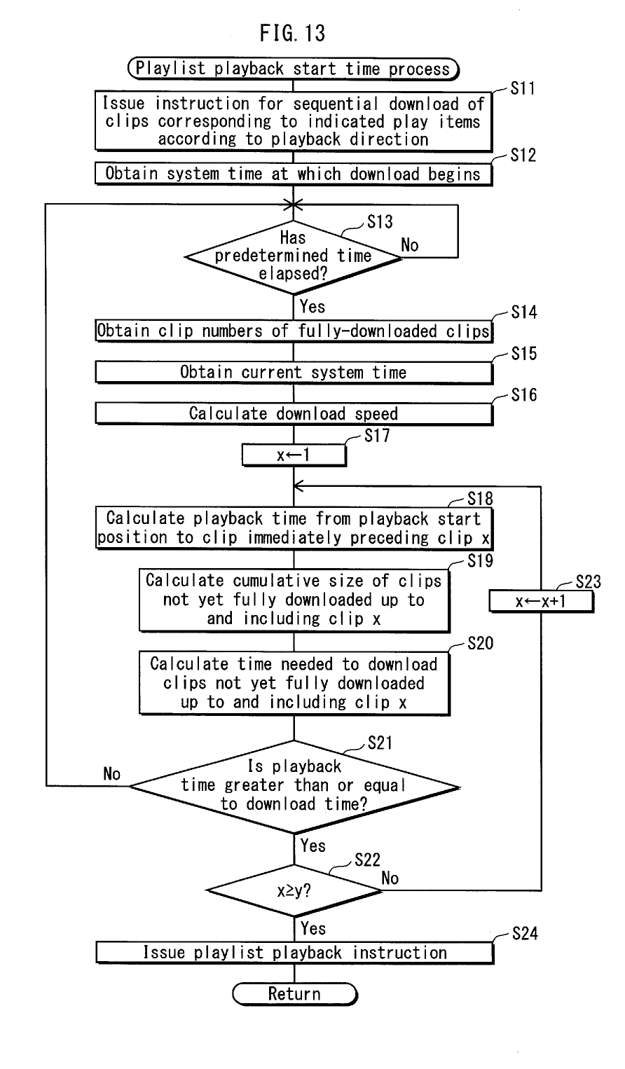

FIG. 13 is a flowchart showing the processing order for the playlist playback start time process. In the flowchart, x is a variable specifying one of the audiovisual clips not yet fully downloaded. When x=1, the clip closest to the playback start position among the clips not yet fully downloaded is specified. As x increases, the specified clip is progressively more distant from the playback start position. y indicates the total number of audiovisual clips not yet fully downloaded.

First, in step S11, the playback controller 121 instructs the network interface, through the stream downloader 123, to download the clips corresponding to the specified play items sequentially, in the playback direction.

In step S12, the system time at which downloading begins is obtained from the system time generator 116.

Once a predetermined time has elapsed (Yes in step S13), the clip numbers of fully-downloaded audiovisual clips and the current system time are obtained in steps S14 and S15.

In step S16, the network playback information is referenced to calculate the total file size of the clips corresponding to the clip numbers so obtained. The clip download speed is then calculated according to the total file size and the difference between the current system time and the system time at which downloading began.

In step S17, the variable x is set to 1.

In step S18, the playback time interval from the playback start position to the clip immediately preceding the clip specified by x is calculated by referencing the network playback information.

In step 19, the cumulative download size of the clips up to and including the clip specified by x is downloaded is calculated by referencing the network playback information.

In step S20, the remaining download time until the clip designated by x is downloaded is calculated according to the cumulative download size and the download speed calculated in step S16.

In step S21, a determination is made as to whether the playback time is equal to or longer than the download time.

If the download time is deemed longer than the playback time, then the process returns to step S13.

If the playback time is deemed equal to or longer than the download time, then the process moves to step S22. In step S22, the relation x≧y is checked. In other words, a determination is made as to whether any other clips remain not yet fully downloaded.

If the determination is negative, i.e., if there are more clips not yet fully downloaded, then the variable x is incremented by 1 in step S23, and the process returns to step S18.

If there are no other clips not yet fully downloaded, i.e., if the relation of step S21 is satisfied for all clips not yet fully downloaded, then the process moves to step S24. In step S24, the playback control engine 111 is instructed, through an API, to begin playlist playback.

### (Priority Download Process)

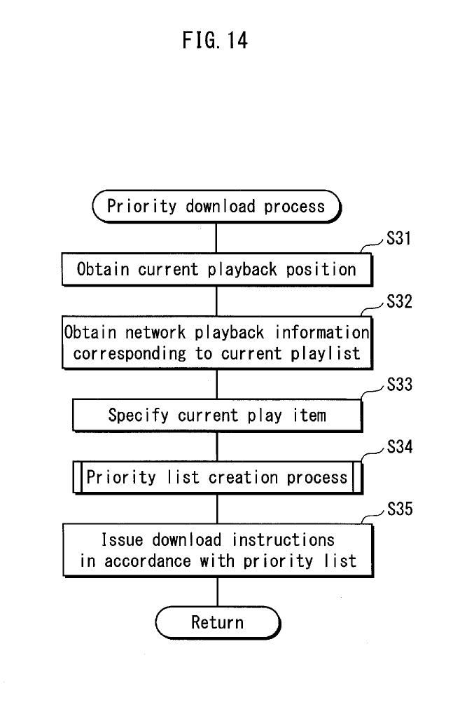

FIG. 14 is a flowchart showing the processing order for the priority download process.

First, in step S31, the playback clip detector 128 obtains the current playback position from the PSR set 115.

In step S32, the network playback information corresponding to the current playlist is obtained.

In step S33, the current playback position is cross-referenced with the network playback information to specify a playback interval in which the playback position is included. Then, the current play item is specified through the clip number of the playback interval so specified.

In step S34, the priority order determiner 122 performs a priority list creation process, which will be described later. Finally, in step S35, audiovisual clip download instructions are issued in accordance with the priority list so created.

### (Priority List Creation Process)

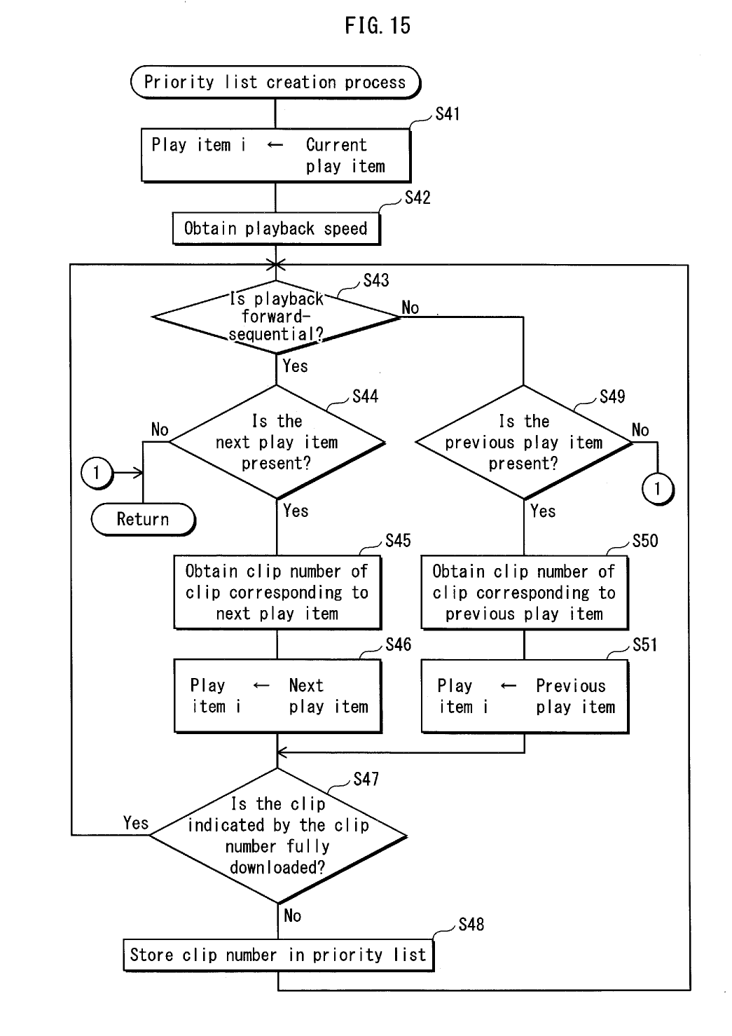

FIG. 15 is a flowchart showing the processing order for the priority list creation process. In this flowchart, i is a variable specifying one of the play items.

First, in step S41, the priority order determiner 122 sets the play item i as the current play item.

In step S42, the playback speed is obtained. In step S43, the direction of playlist playback is determined according to the playback speed so obtained. This determination is made according to whether the playback speed is positive or negative, for instance.

If the playback speed is positive, i.e., if the playback direction is deemed to be forward, then in step S44, the network playback information is used to determine whether or not the next play item, namely the play item that follows the current play item, is present. Here, for example, if the current play item is play item #3, then the next play item is play item #4 (see FIG. 3).

If the next play item is not deemed present, the process ends because, if the next play item to be played back does not exist, then neither does the audiovisual clip that would be downloaded therefor.

If the next play item is deemed present, then the process moves to step S45. In step S45, the clip number of the corresponding audiovisual clip is obtained.

In step S46, the next play item is set as play item i.

In step S47, a determination is made as to whether or not the audiovisual clip corresponding to the indicated clip number has been fully downloaded.

If the audiovisual clip corresponding to the indicated clip number is deemed to have already been fully downloaded, the process returns to step S43.

If the audiovisual clip corresponding to the indicated clip number is deemed to not have been fully downloaded, the process moves on to step S48. In step S48, the clip number is stored in the priority list, and the process returns to step S43. The audiovisual clip corresponding to the clip number first stored in the priority list receives the highest download priority.

If, in step S43, the playback speed is negative, i.e., if the playback direction is not deemed to be forward, then in step S49, the network playback information is used to determine whether or not the previous play item, namely the play item that precedes the current play item, is present. Here, for example, if the current play item is play item #3, then the previous play item is play item #2 (see FIG. 3).

If the previous play item is not deemed present, the process ends because, if the previous play item to be played back does not exist, then neither does the audiovisual clip that would be downloaded therefor.

If the previous play item is deemed present, then the process moves to step S50. In step S50, the clip number of the corresponding audiovisual clip is obtained.

In step S51, the previous play item is set as play item i. The process then advances to step S47. The processing that follows is as described above.

The priority list can be created by following the above process. The priority list contains clip numbers in descending order of download priority.

Accordingly, by issuing download instructions according to the priority list, downloading can proceed sequentially such that high-priority audiovisual clips, namely the clips not yet fully downloaded that are closest to the current clip, are downloaded first. For example, if playback is proceeding in reverse order and the audiovisual clip referenced by the play item that precedes the current play item has not been downloaded, then that clip is prioritized for download.

As a result, the probability that a playable state is indicated by the state information of the subsequent clip to be played back after the current clip can be increased.

In step S44, the process ends if the next play item to be played back is deemed not to exist. However, the process may also backtrack to the play item that precedes the current play item to search for audiovisual clips not yet downloaded.

### (Playback State Monitoring Process)

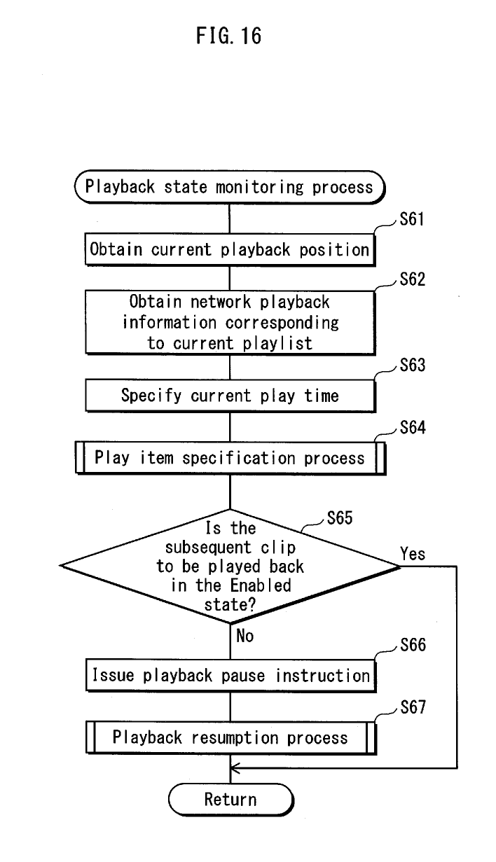

FIG. 16 is a flowchart showing the processing order for the playback state monitoring process. The process shown in this flowchart may be performed regularly (every few seconds, for example) or irregularly. The process of steps S61 through S63 shown in this flowchart is identical to that of steps S31 through S33 shown in FIG. 14 and thus omitted.

Once the current play item is specified in step S63, the playback clip detector 128 performs a later-described play item specification process in step S64.

In step S65, the playback controller 121 determines whether or not the subsequent audiovisual clip is in the Enabled state.

If this determination is affirmative, playback continues.

If this determination is negative, then in step S66, the playback control engine 111 is instructed via the API to pause playback.

Afterward, in step S67, a playback resumption process is performed. The playback resumption process may, for example, consist of the steps shown in FIG. 13 from step S13 onward.

### (Play Item Specification Process)

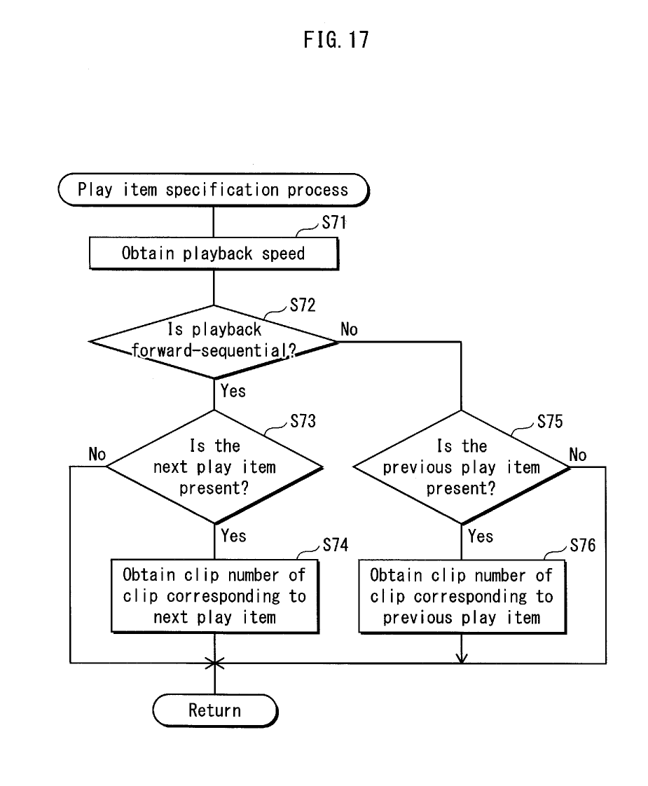

FIG. 17 is a flowchart showing the processing order for the play item specification process. In step S71, the playback speed is obtained by the playback clip detector 128. In step S72, the direction of playlist playback is determined according to the playback speed so obtained.

If the playback direction is deemed to be forward, then in step S73, the network playback information is used to determine whether or not the next play item, namely the play item that follows the current play item, is present.

If the next play item is not deemed present, the process ends because, if the next play item to be played back does not exist, then neither does the audiovisual clip that would be downloaded therefor.

If the next play item is deemed present, then the process moves to step S74. In step S74, the clip number of the corresponding audiovisual clip is obtained.

If, in step S72, the playback direction is not deemed to be forward, then in step S75, the network playback information is used to determine whether or not the previous play item, namely the play item that precedes the current play item, is present.

If the previous play item is not deemed present, the process ends because, if the previous play item to be played back does not exist, then neither does the audiovisual clip that would be downloaded therefor.

If the previous play item is deemed present, then the process moves to step S76. In step S76, the clip number of the corresponding audiovisual clip is obtained.

Thus, the subsequent play item to be played back can be specified independently of the direction of playlist playback. Accordingly, the playback state monitoring process can be performed irrespective of the direction of playlist playback.

### (Playlist Playback Process)

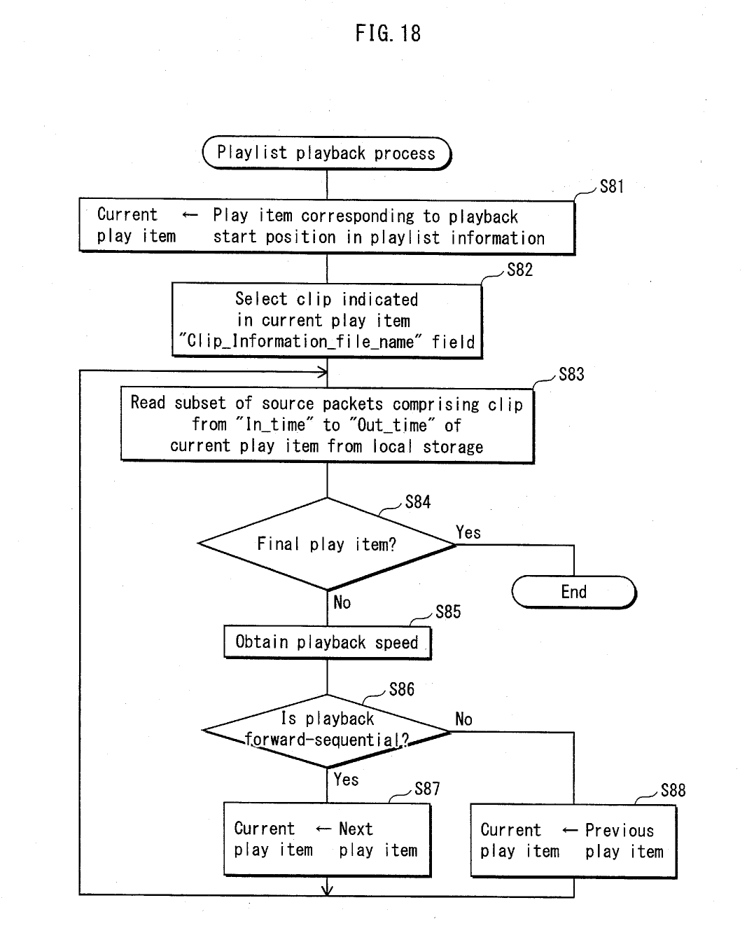

FIG. 18 is a flowchart showing the processing order for the playlist playback process. In step S81, the playback control engine 111 sets the play item corresponding to the playback start position within the playlist information as the current play item.

In step S82, the audiovisual clip indicated in the “Clip_information_file_name” field of the current play item is selected.

Subsequently, steps S83 through S88 are executed in a loop. In step S83, the subset of the source packets that comprise the audiovisual clip from the fields “in_time” to “out_time” of the current play item are read from the local storage 300.

In step S84, a determination is made as to whether or not other play items exist.

If this determination is negative, the process ends.

If this determination is affirmative, then in step S85, the playback speed is obtained from the PSR set 115. Next, in step S86, the direction of playlist playback is determined according to the playback speed so obtained.

If the playback direction is deemed to be forward, then in step S87, the next play item, namely the play item that follows the current play item, is set as the new current play item.

If the playback direction is not deemed to be forward, then in step S88, the previous play item, namely the play item that precedes the current play item, is set as the new current play item.

After the new current play item is set in step S87 or step S88, the process returns to step S83.

According to the above-described Embodiment, the BD-J application includes network playback information and obtains the current playback time from the PSR set 115. Thus, the audiovisual clip currently being played back can be specified by cross-referencing the playback time and the network playback information.

Also, the subsequent audiovisual clip to be played back can be specified by obtaining the playback speed from the PSR set 115 and determining the playback detection therefrom.

Once the subsequent audiovisual clip is determined, the state information thereof can be obtained from the state manager 108. Thus, whether or not the subsequent audiovisual clip is in a playable state can be determined.

Accordingly, if the subsequent audiovisual clip is not in a playable state, playback can be prevented from stopping by instead pausing the current audiovisual clip.

### (Variation 1-1)

The following describes a variation in which a substitute video is played back by modifying the content of the playback controls by BD-J application when the subsequent audiovisual clip to be played back is not in the Enabled state.

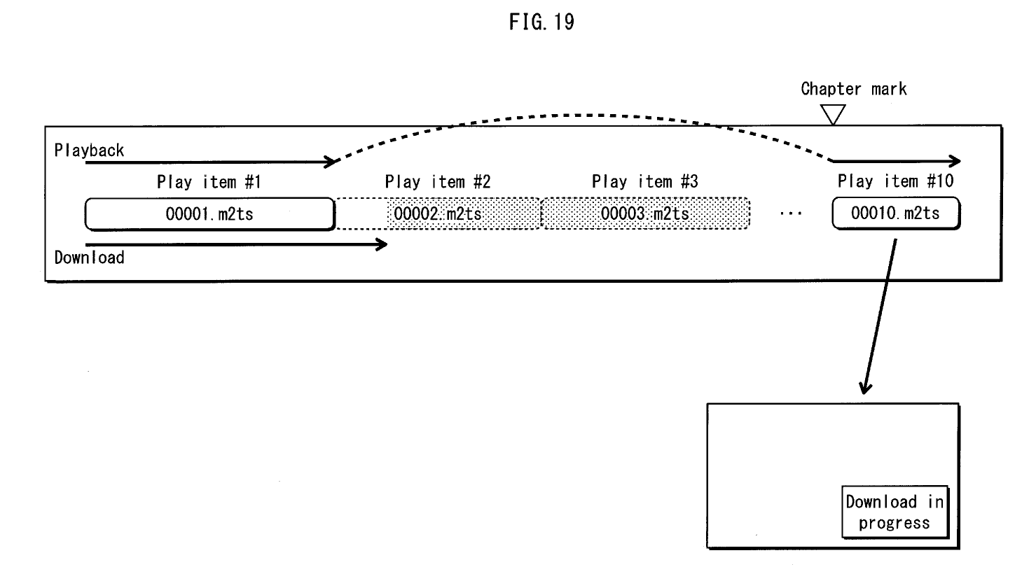

FIG. 19 illustrates the playback controls by the BD-J application when the subsequent audiovisual clip to be played back is not in the Enabled state.

The top row of FIG. 19 shows a playlist. This playlist comprises ten play items, #1, #2, #3 . . . #10. The ten play items respectively reference files named “00001.m2ts”, “0002.m2ts”, “00003.m2ts” . . . “00010.m2ts”. All of these consist of content from the update kit stored in local storage, and, with the exception of play item #10, each has network attributes assigned thereto. The file “00001.m2ts” has already been fully downloaded and set to the Enabled state by the BD-J application. The files from “00002.m2ts” onward either have not yet been downloaded and are thus in the Missing state, or have been downloaded but are in the Disabled state.

As play item #10 has no network attributes assigned thereto, the file “00010.m2ts” referenced thereby must be fully downloaded when the virtual package is constructed.

The content of “00010.m2ts” is a user notification audiovisual clip. As shown in the lower row of FIG. 19, this may be, for example, an image that includes the text string “Download in progress”. A chapter mark may also be assigned to play item #10 so as to correspond to this audiovisual clip.

When the playback control engine 111 performs playback sequentially beginning with the leading play item of the playlist, at some point during the playback of “00001.m2ts”, the BD-J application makes an instruction to play back “00010.m2ts” by indicating the chapter mark because the download of “00002.m2ts” is not yet complete.

According to the above, “00010.m2ts” can be played back through instructions from the BD-J application when the subsequent audiovisual clip to be played back is not in the Enabled state. Thus, the user can be notified that clip download is in progress while avoiding the need to stop playback.

Also, once “00002.m2ts” is fully downloaded and comes to be in a playable state, playback of “00001.m2ts” can be resumed. The playback position reached immediately before making the switch may also be stored.

The above describes playback guaranteed through the use of an audiovisual clip to which no network information is assigned. However, playback can also be guaranteed through the use of an audiovisual clip that does have network information as long as download of such a clip is fully completed before playback begins.

Also, the above mentions that a chapter mark may be assigned to play item #10 to indicate the playback of “00010.m2ts”. However, the playback start time for play item #10 may also be indicated.

Furthermore, the user information audiovisual clip may either be a main video or a sub-video. In addition, the audiovisual clip may be in the current playlist, or else be a clip in a different playlist. If “00010.m2ts” is included in a playlist other than the playlist currently undergoing playback, then the BD-J application may select the other playlist and begin playback of play item #10 therein. In such a case, the BD-J application may contain, for example, information indicating the playlist that includes play item #10.

### (Variation 1-2)

The following describes a variation in which two different priority lists are created to reflect the presence or absence of chapter marks.

While playing back a playlist, the playback device can receive special playback instructions from the user, such as Skip. When this occurs, streaming-like playback cannot necessarily be realized with a minimum pause frequency even if the audiovisual clips are downloaded according to the priority list as described above.

The following variation describes a method for realizing streaming-like playback while pausing audiovisual clip playback as little as possible, despite the reception of special playback instructions such as Skip during playlist playback.

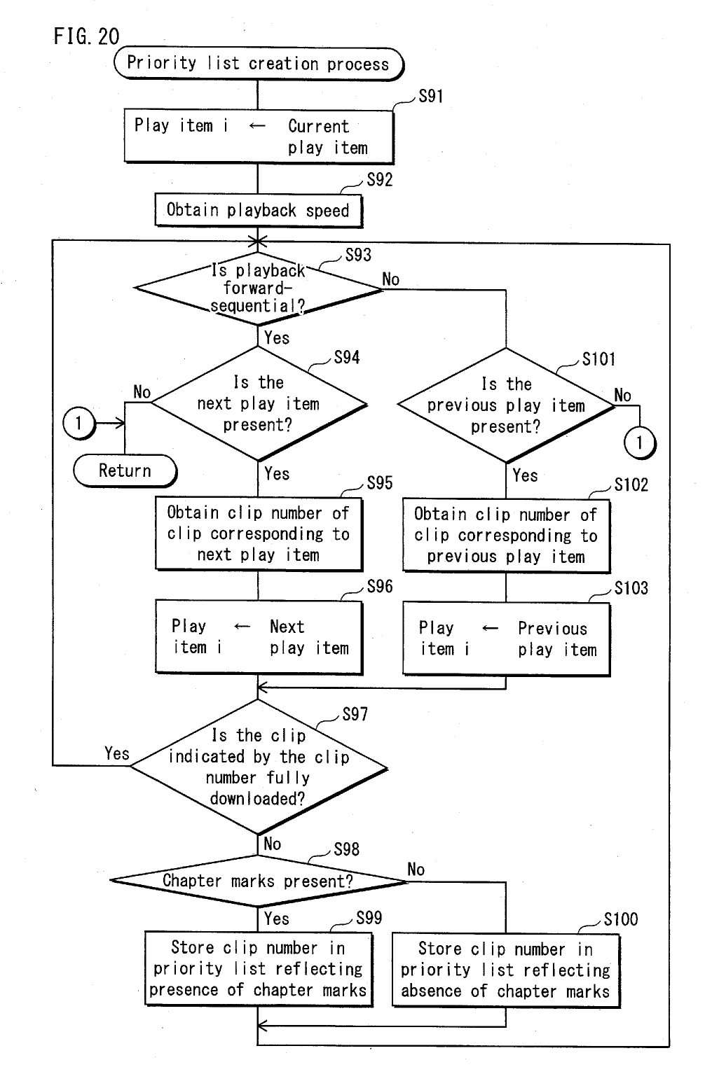

FIG. 20 is a flowchart showing the processing order for the priority list creation process pertaining to Variation 1-2. In this flowchart, i is a variable specifying one of the play items.

The process of steps S91 through S97 shown in this flowchart is identical to that of steps S41 through S47 shown in FIG. 15, and that of steps S101 through 5103 is identical to that of steps S49 through S51. These steps are thus omitted.

In step S97, if the audiovisual clip corresponding to the indicated clip number is deemed to have not yet been fully downloaded, the process moves on to step S98. In step S98, a determination is made as to whether or not there is a chapter mark in the play item.

If the play item features a chapter mark, then in step S99, the clip number is contained in a priority list that reflects the presence of chapter marks.

If a chapter mark is not found in the play item, then in step S100, the clip number is contained in a priority list that reflects the absence of chapter marks.

Thus, in the present Variation, the priority order determiner 122 creates two priority lists reflecting the presence or absence of chapter marks.

Then, if a Skip instruction or the like is received from the user, an instruction is issued to download the audiovisual clips according to the priority list that reflects the presence of chapter marks.

A specific example follows, made with reference to FIG. 3. Let the current playback position be in play item #1, and let the clip “00002.m2ts” and all subsequent clips not yet be fully downloaded. In this case, the next play item featuring a chapter mark is play item #3. Accordingly, if a Skip instruction is received from the user, then according to the priority list that reflects the presence of chapter marks, the clip with the highest download priority will be “00003.m2ts” rather than “00002.m2ts”. The next highest download priority goes to “00005.m2ts”.

The probability that audiovisual clip playback will be paused can be reduced despite the occurrence of irregular playback caused by special playback instructions such as skip by downloading the corresponding clips, i.e., clips referenced by play items featuring chapter marks, in priority order.

Also, audiovisual clip download can proceed according to the priority list that reflects the absence of chapter marks as long as no such Skip instruction is received from the user.

Thus, by properly using two priority lists that reflect the presence or absence of chapter marks, streaming-like playback can be realized in which the probability of an audiovisual clip being paused during playback is minimized despite the reception of a Skip instruction from the user.

The above describes the creation of two priority lists reflecting the presence and absence of chapter marks. However, the variation is not limited as such. Lists may be created to reflect, for instance, the presence of resume points from which the user wishes to begin viewing, or breaking points for commercials and the like.

Furthermore, the priority list that reflects the presence of chapter marks is not restricted to use for download when a Skip instruction is received from the user, but may also be used in the absence of such an instruction.

### (Variation 1-3)

The following describes a variation in which the time needed to download audiovisual clips referenced by play items featuring chapter marks is reduced.

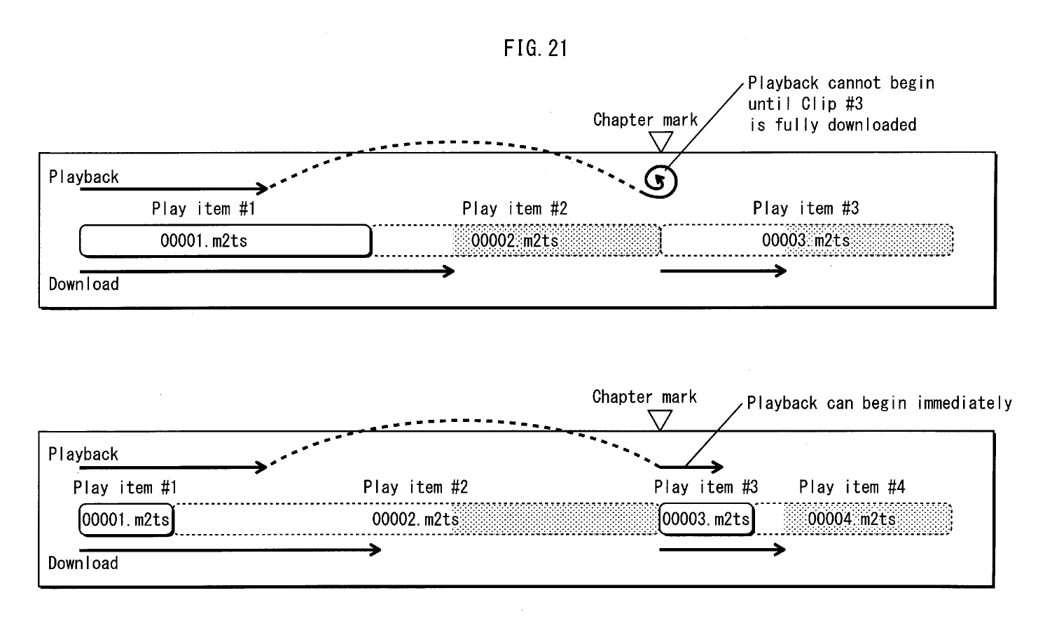

FIG. 21 illustrates the manner in which the time needed to download audiovisual clips referenced by play items featuring chapter marks is reduced. The top and bottom rows of FIG. 21 each show a playlist. The playlist shown in the bottom row of FIG. 21 differs in that the file “00003.m2ts” referenced by the play item that has the chapter mark is smaller in size than the other audiovisual clips. That is, in the playlist shown in the top row of FIG. 21, the audiovisual clips are of equal playback length. Thus, when a chapter skip instruction is issued through user operations during the playback of “00001.m2ts”, playback of “00003.m2ts” may be impossible to begin immediately if more time is required for download thereof to be completed.

On the other hand, in the playlist shown in the bottom row of FIG. 21, the file “00003.m2ts” is set up with a smaller size than the other audiovisual clips. Accordingly, when a chapter skip instruction is issued through user operations during the playback of “00001.m2ts”, the time required to download “00003.m2ts”, if not already fully downloaded, is lower relative to that required for the example in the top row of FIG. 21. Thus, playback of “00003.m2ts” can begin earlier.

One method for reducing the size of the audiovisual clip referenced by play items possessing chapter marks is to reduce the bitrate of such clips. By reducing the bitrate, the size of the files can be reduced despite the playback intervals remaining identical. Thus, by preparing multiple clips of varying bitrates on the server side, the BD-J application can be configured to select clips to be downloaded in response to the download transfer rate.

According to this structure, audiovisual clips can be downloaded in a manner reflecting the network environment to which the playback device is connected.

Alternatively, multivarious audiovisual clips may be prepared server-side such that picture quality or real-time characteristics are prioritized. The user can then select such a priority and the BD-J can accordingly select the appropriate clips for download.

According to such a structure, audiovisual clips can be downloaded so as to reflect the wishes of the user.

Alternatively, by arranging for the playback time of the audiovisual clips referenced by play items featuring chapter marks to be greater than or equal to the time required to download the subsequent clip, streaming-like playback can continue without pausing the clip currently undergoing playback despite changes in playback position.

### Embodiment 2

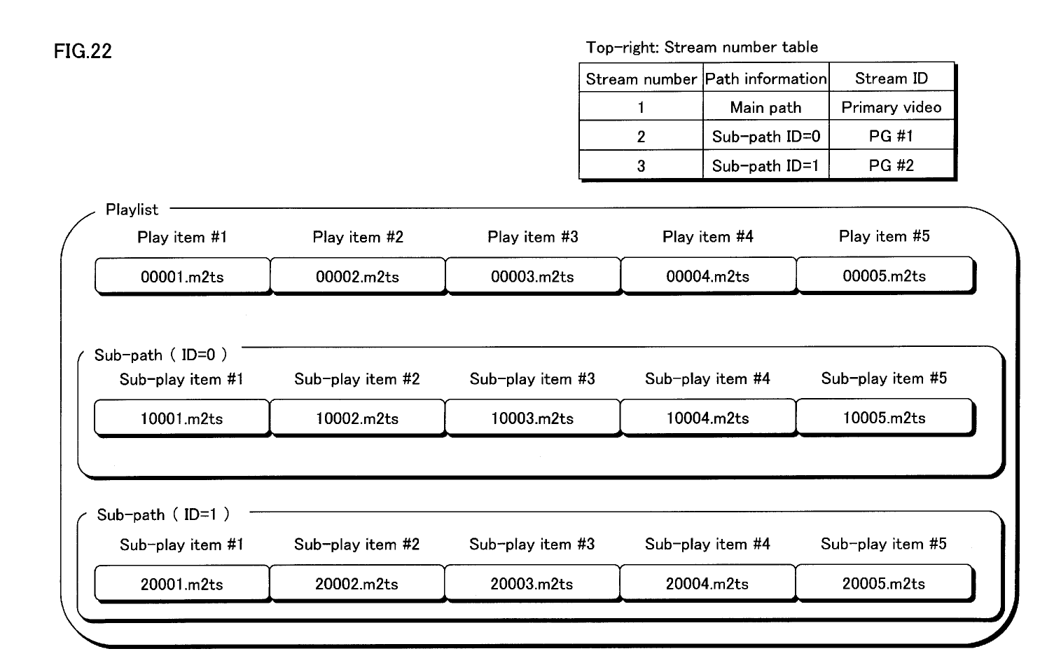

The present Embodiment describes a playlist that includes sub-paths. FIG. 22 shows a specific example of a playlist pertaining to the present Embodiment. As shown, the playlist comprises one main path and two sub-paths (sub-path (ID=0) and sub-path (ID=1)). The description of the main path is omitted as such a description has already been provided. The sub-path with ID=0 includes five sub-play items, #1, #2, #3, #4, and #5. The sub-path with ID=1 also includes five sub-play items, #1, #2, #3, #4, and #5. Both of the sub-paths are synchronous. Each references audiovisual clips multiplexed with presentation graphics consisting of subtitle data in different languages, for example.

The sub-play items #1, #2, #3, #4, and #5 in the sub-path with ID=0 respectively reference the files “10001.m2ts”, “10002.m2ts”, “10003.m2ts”, “10004.m2ts”, and “0005.m2ts”.

The sub-play items #1, #2, #3, #4, and #5 in the sub-path with ID=1 respectively reference the files “20001.m2ts”, “20002.m2ts”, “20003.m2ts”, “20004.m2ts”, and “20005.m2ts”.

The main path play items have a stream number table such as that shown in the upper-right corner of FIG. 22. This stream number table holds three entries to which the stream numbers 1, 2, and 3 are respectively assigned. These three entries consist of playback permission information for the primary video stream referenced by the play item information in the main path, the presentation graphics stream (PG #1) included in the audiovisual clips referenced by the sub-play items for the sub-path with ID=0, and the presentation graphics stream (PG #2) included in the audiovisual clips referenced by the sub-play items for the sub-path with ID=1.

For example, if the current subtitle stream number is “2”, then PG #1, associated with the sub-path with ID=0, are played back in sync with the play items being played back.

### Specific Example

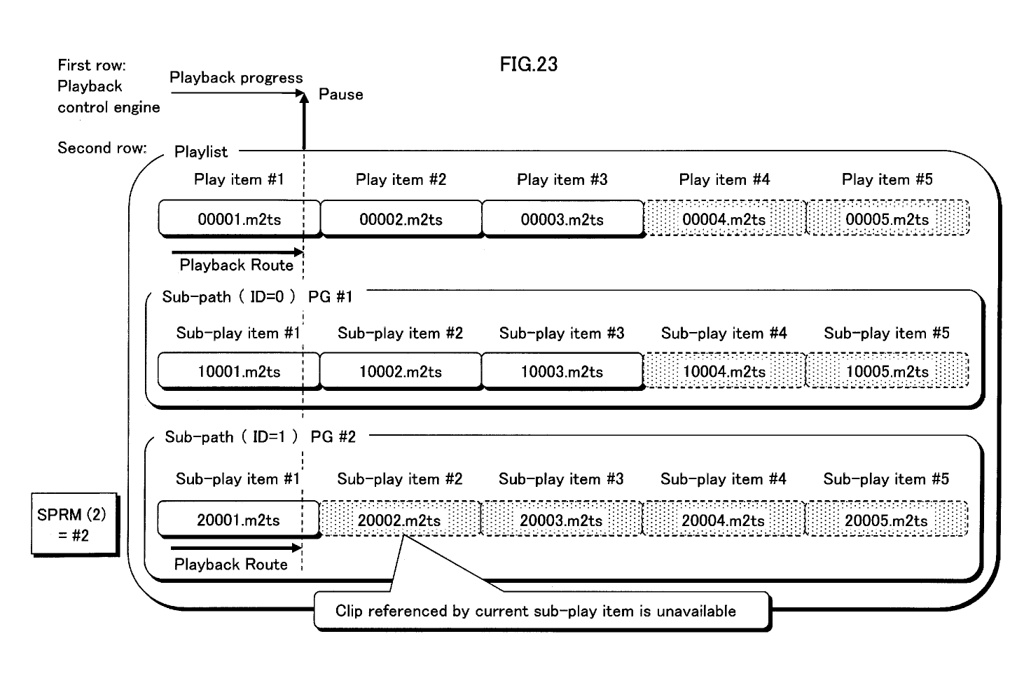

FIG. 23 is a schematic diagram of streaming-like playback involving sub-play items. The arrows shown in FIG. 23 indicate the current playback progress.

The first row shows the playback state of the playback control engine 111. The second row shows the playlists pertaining to the present Embodiment. As shown in the second row, the files “00001.m2ts”, “00002.m2ts”, “00003.m2ts”, “10001.m2ts”, “10002.m2ts”, “10003.m2ts”, and “20001.m2ts” have already been fully downloaded and set to the Enabled state by the BD-J application. All other clips are in an Unavailable state.

When the playback control engine 111 sequentially plays back the playlist from the beginning, playback can proceed up to play item #1 and sub-play item #1 because the current sub-play item information is set to sub-play item #1, which belongs to the sub-path with ID=1.

However, the BD-J application pauses playback of play item #1 and sub-play item #1 before play item #2 and sub-play item #2 become the current play item and current sub-play item because the clip “20002.m2ts” referenced by sub-play item #2 and corresponding to play item #2 is Unavailable.

Therefore, as shown is the top row, the playback control engine 111 plays back play item #1 and sub-play item #1 up to a certain point, but then pauses upon receiving an instruction to such effect from the BD-J application.

Thus, the BD-J application can transmit a request to the playback control engine 111 to pause the playback of the files “00001.m2ts” and “20001.m2ts” before playback of the file “20002.m2ts” that follows “20001.m2ts” is attempted. During the pause, an image can remain displayed on the screen. Accordingly, playback stop caused by the file “20002.m2ts” not being in a playable state can be avoided.

Also, playback of the play item alone is prevented. Thus, play item playback can be prevented from proceeding without subtitle data display.

### (Priority Download Process)

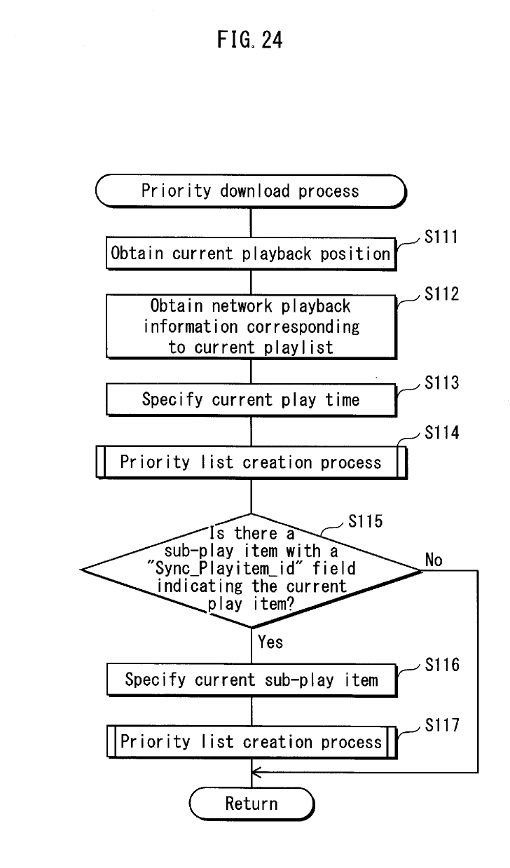

FIG. 24 is a flowchart showing the processing order for the priority download process pertaining to the present Embodiment. The process of steps S111 through S114 shown in this flowchart is identical to that of steps S31 through S34 shown in FIG. 14 and thus omitted.

In step S115, after the priority list creation process of step S114, the priority order determiner 122 determines whether or not any sub-play item has a “Sync_Playitem_id” that indicates the current play item.

If this determination is affirmative, then in step S116, the current sub-play item is specified. Then, in step S117, a priority list creation process is performed for the sub-play items. The priority list creation process for the sub-play items is fundamentally identical to the priority list creation process shown in FIG. 15, with the sole difference being that the play items are replaced by sub-play items.

### (Playback State Monitoring Process)

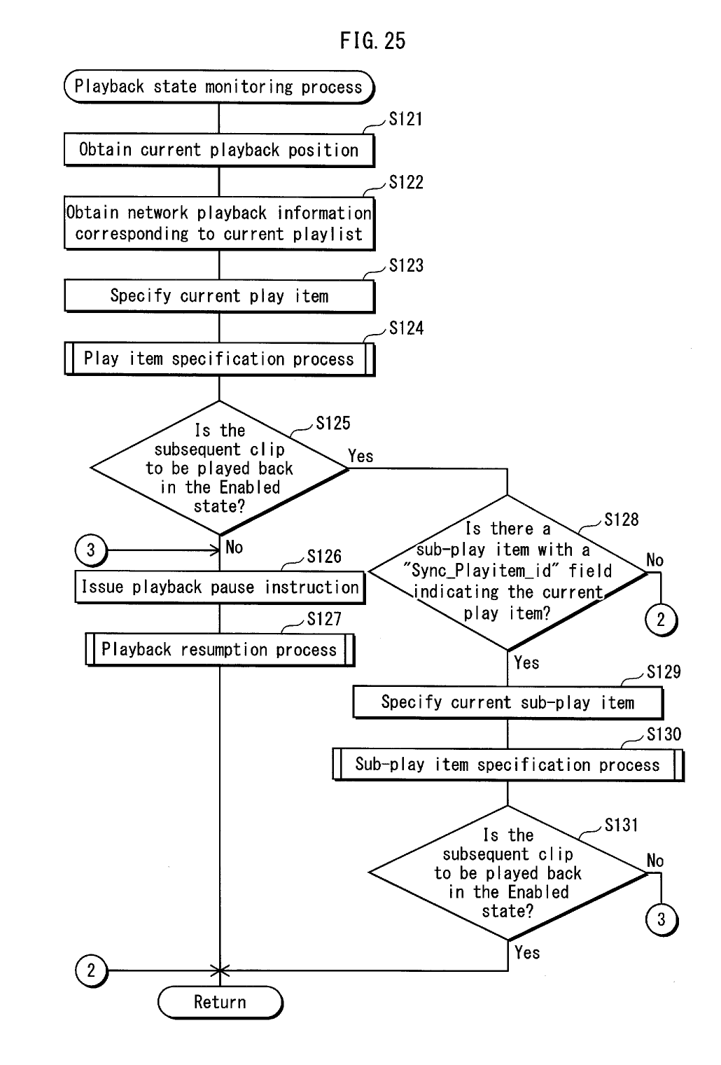

FIG. 25 is a flowchart showing the processing order for the playback state monitoring process pertaining to the present Embodiment. The process of steps S121 through S127 shown in this flowchart is identical to that of steps S61 through S67 shown in FIG. 16 and thus omitted.

If the determination made in step S125 is such that the subsequent audiovisual clip to be played back is in the Enabled state, then in step S128, a further determination is made as to whether or not any sub-play item has a “Sync_Playitem_id” that indicates the current play item.

If the determination is such that no such sub-play item exists, then play item playback resumes because there is no sub-play item to play back in sync with the current play item.

If the determination is such that such sub-play items exist, then in step S129, the current sub-play item is specified, and in step S130, a sub-play item specification process is performed. The sub-play item specification process is fundamentally identical to the play item specification process shown in FIG. 17, with the sole difference being that the play items are replaced by sub-play items.

In step S131, after the sub-play item specification process in step S130, a determination is made as to whether or not the subsequent audiovisual clip to be played back (the clip referenced by the specified sub-play item) is in the Enabled state.

If the determination is affirmative, then playback continues. If the determination is negative, then in step S126, the BD-J application issues an instruction to pause playback.

### (Playlist Playback Process)

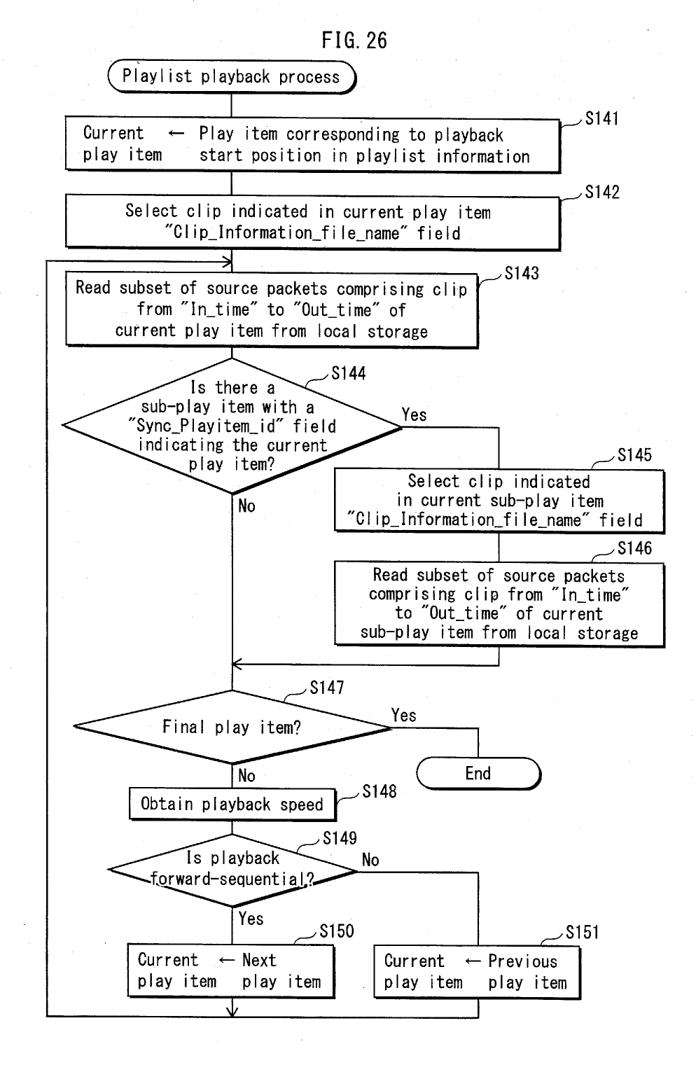

FIG. 26 is a flowchart showing the processing order for the playlist playback process pertaining to the present Embodiment. The process of steps S141 through S143 and of steps S147 through S151 shown in this flowchart is identical to that of steps S81 through S83 and of steps S84 through S88, respectively, shown in FIG. 18. These steps are thus omitted.

In step S144, after the process of step S143, a determination is made as to whether or not any sub-play item has a “Sync_Playitem_id” that indicates the current play item.

If the determination is affirmative, then in step S145, the audiovisual clip indicated in the field “Clip_information_file_name” of the current sub-play item is selected.

In step S146, the subset of the source packets that comprise the audiovisual clip from the fields “in_time” to “out_time” of the current sub-play item are read from the local storage 300. The process then moves on to step S147.

### (Variation 2-1)

The following describes a variation in which a sub-path change request (such as subtitle track change) is made by the user. Streaming-like playback of subtitle data in sync with the playback of a main feature recorded on the BD-ROM 200 serves as a usage example.

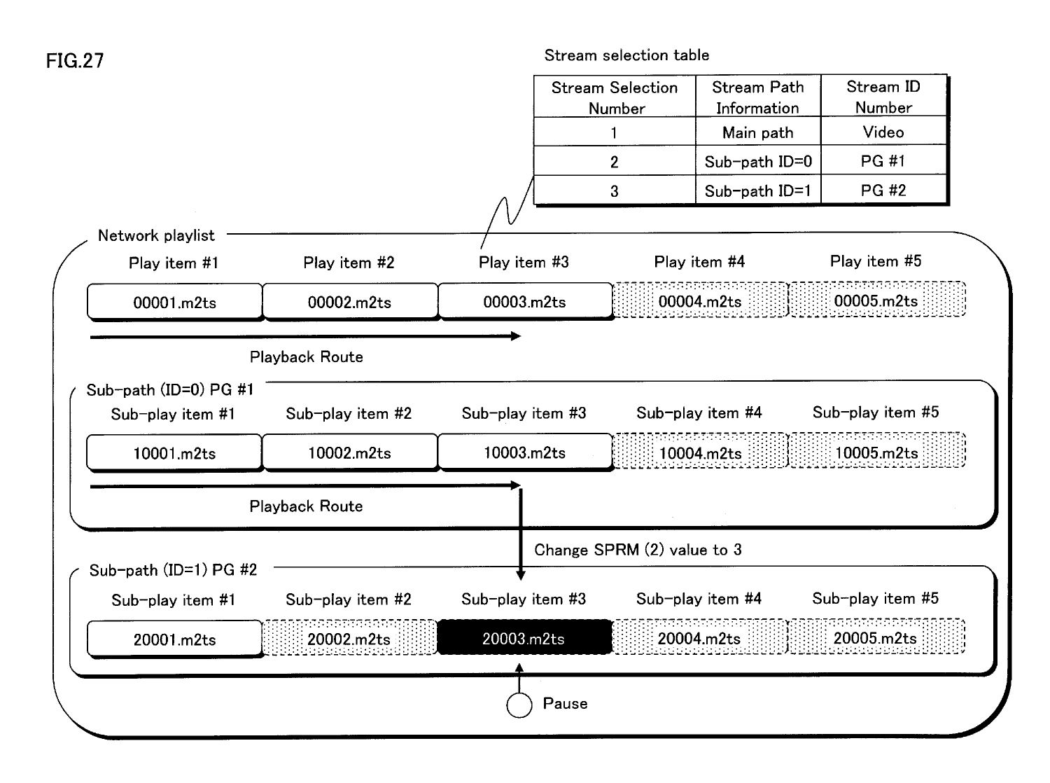

FIG. 27 illustrates a scenario in which a subtitle track change is requested by the user. The current playback position is accordingly changed over from the file “10003.m2ts” referenced by sub-play item #3 from the sub-path with ID=0 to the file “20003.m2ts” referenced by sub-play item #3 from the sub-path with ID=1. The files “00001.m2ts”, “00002.m2ts”, “00003.m2ts”, “10001.m2ts”, “10002.m2ts”, “10003.m2ts”, and “20001.m2ts” have already been fully downloaded and set to the Enabled state by the BD-J application. All other clips are in an Unavailable state.

When the value in SPRM (2) is changed to “3” by user operations or by other means, the subtitle track in sub-play item #3 from the sub-path with ID=1 is played back. The file “20003.m2ts” referenced by sub-play item #3 is an Unavailable clip. Therefore, the BD-J application makes an instruction to the effect that playback of “00003.m2ts” and “10003.m2ts” is paused just as track changeover occurs.

As described above, if the clip containing the changeover destination subtitle stream is in the Missing state or in the Disabled state when a subtitle track change request is made, then the playback control engine 111 simultaneously pauses playback while making the change as per the instructions of the BD-J application.

### (Playback State Monitoring Process for Sub-Path Change)

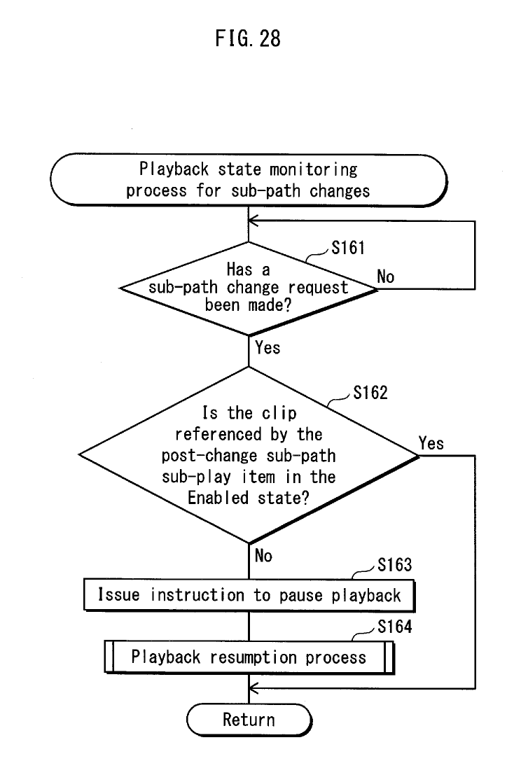

FIG. 28 is a flowchart showing the processing order of the playback state monitoring process for sub-path changes.

In step S162, after the sub-path change request has been made by the user in step S161, a determination is made as to whether or not the clip referenced by the sub-play item of the post-change sub-path is in the Enabled state.

If the determination is affirmative, then playback continues. However, if the determination is such that the clip referenced by the sub-play item of the post-change sub-path is not in the Enabled state, then in step S163, playback is paused as per an instruction from the BD-J application.

Afterward, in step S164, the playback resumption process is performed.

### (Variation 2-2)

The following describes a method by which playback can continue despite the audiovisual clip referenced by the subsequent sub-play item to be played back not being in the Enabled state.

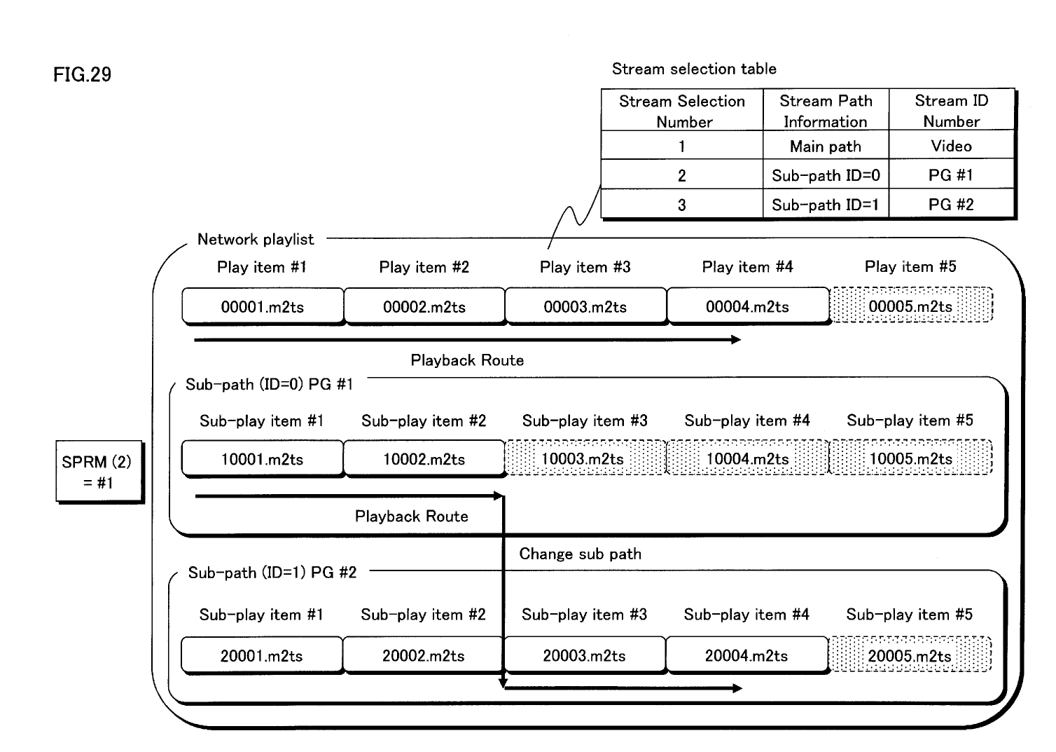

FIG. 29 illustrates playback control in a situation where the clip referenced by the subsequent sub-play item to be played back is not in the Enabled state.

When the playback control engine 111 sequentially plays back the playlist from the beginning, playback can proceed up to play item #2 and sub-play item #2 because the current sub-play item information is set to sub-play item #1, which belongs to the sub-path with ID=0.

However, the file “10003.m2ts” referenced by sub-play item #3 and corresponding to play item #3 is an Unavailable clip. Therefore, supposing that playback of the sub-path with ID=0 continues as-is, then the BD-J application will make an instruction such that playback of play item #2 and sub-play item #2 is paused.

Meanwhile, the file “20003.m2ts” referenced by sub-play item #3 from the sub-path with ID=0 is in the Enabled state.

In the present Variation, the BD-J application changes from the sub-path with ID=0 to the sub-path with ID=1 when playback of sub-play item #3 begins.

Playback can thus continue without pausing, even if the clip referenced by the subsequent sub-play item to be played back is not in the Enabled state.

Also, playback of the play item alone is prevented. Thus, play item playback can be prevented from proceeding without subtitle data display.

### (Playback State Monitoring Process)

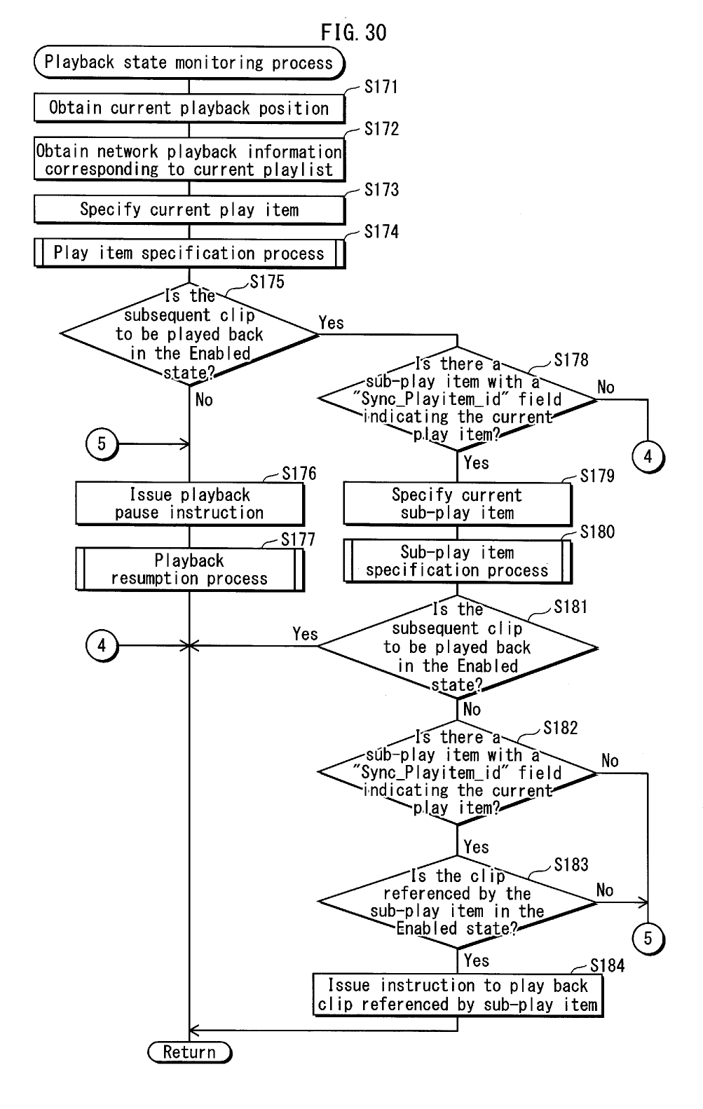

FIG. 30 is a flowchart showing the processing order for the playback state monitoring process pertaining to the present Variation. The process of steps S171 through S181 shown in this flowchart is identical to that of steps S121 through S131 shown in FIG. 25 and thus omitted.

If the determination made in step S181 is such that the subsequent audiovisual clip to be played back is not in the Enabled state, then in step S182, a further determination is made as to whether or not any other sub-play item has a “Sync_Playitem_id” that indicates the current play item.

If such a sub-play item is found, then a determination is made in step S183 as to whether or not the audiovisual clip referenced by the sub-play item so found is in the Enabled state.

If this determination is affirmative, then in step S184, the BD-J application makes an instruction such that the clip referenced by the sub-play item so found is played back.

### Embodiment 3

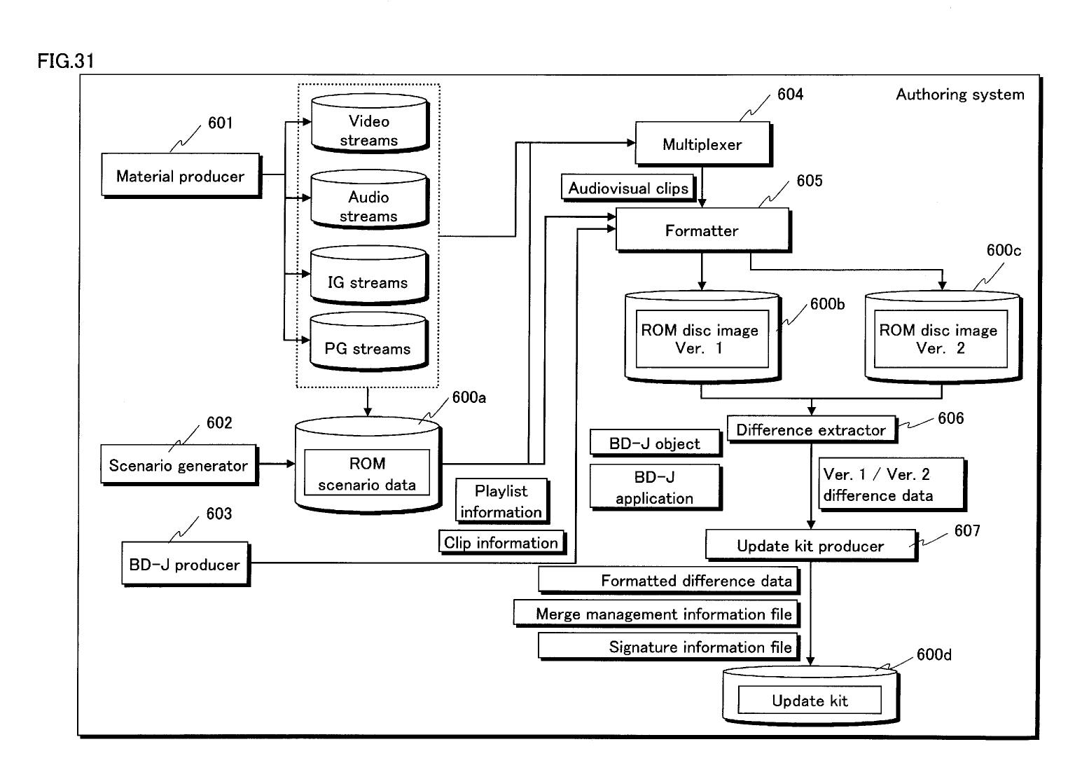

The present Embodiment describes an authoring system for authoring update kits. FIG. 31 is a configuration diagram of the authoring system. As shown, the authoring system comprises storage 600a, b, and c, a material producer 601, a scenario generator 602, a BD-J producer 603, a multiplexer 604, a formatter 605, a difference extractor 606, and an update kit producer 607.

Storage 600a, b, and c each store ROM scenario data, ROM disc image version 1, and ROM disc image version 2, respectively.

The material producer 601 creates streams, such as video, audio, presentation graphics, and interactive graphics streams.

The material producer creates video streams by encoding uncompressed bitmap images or the like according to a compression standard such as MPEG4-AVC or MPEG2.

The material producer 601 creates audio streams by encoding uncompressed Linear PCM audio or the like according to a compression standard such as AC3.

The material producer 601 creates presentation graphics streams, which serve as subtitle streams, according to a subtitle information file that includes subtitle effects, such as subtitle images, display timing, and fade-in/fade-out information.

The material producer 601 creates interactive graphics streams, which form menu screens, according to bitmap images used in the menus and a menu file that describes the buttons assigned to the menus and the display effects thereof.

The scenario generator 602 creates scenarios according to the stream information for the streams generated by the material producer 601 and the controls of the authoring staff made through the GUI. A scenario is a file such as an index file, a movie object file, or a playlist file.

The scenario generator 602 also creates parameter files used in multiplexing. Parameter files describe which of the audiovisual clips make up each of the streams.

The BD-J producer 603 is used to program the BD-J application. Using a GUI or other user interface, the BD-J application is created by creating source code in accordance with user requests.

The multiplexer 604 multiplexes video, audio, subtitle, button, and other streams described the ROM scenario data to create audiovisual clips in the MPEG2-TS format. Clip information files that correspond to the audiovisual clips are also created at this time.

The multiplexer 604 creates clip information files using the following method. When generating the audiovisual clips, the multiplexer 604 also creates an entry map. Specifically, the multiplexer 604 detects the location of I-pictures in MPEG-2 video streams, I-pictures or IDR pictures in MPEG-4 AVC video streams, and I-pictures in VC-1 streams for each of the streams generated by the material producer 601. Then, the multiplexer 604 registers entry points in an entry map which indicate a correspondence, for each of the above-described pictures, between the presentation timestamp and the number of the MPEG2-TS format audiovisual clip source packet containing the leading data. If two video streams, a primary video and a secondary video, are included in the audiovisual clips, then entry maps are simultaneously created for each.

The multiplexer 604 creates clip information files by pairing the entry maps so generated with property information indicating the audio and video properties of each stream included in the clip.

The formatter 605 arranges the ROM scenario data generated by the scenario generator 602, the BD-J application produced by the BD-J producer 603, as well as the audiovisual clips and clip information files generated by the multiplexer 604 in the format described for previous Embodiments to create a UDF-format disc image. The disc image so generated is then converted into BD-ROM press-readable data. These data can then be used in the pressing step of BD-ROM manufacture.

Two disc images are prepared as part of update kit authoring. The first is a disc image that can be contained on a BD-ROM, while the other is a post-virtual package construction disc image.

The difference extractor 606 extracts difference data by comparing the two ROM disc images stored in storage 600b and 600c. For instance, the difference extractor 606 extracts files not present in the original disc image and updated files by performing a binary comparison.

The update kit producer 607 creates merge management information files and signature files according to the findings of the difference extractor 606 such that the files so created match the update kit data format, and arranges the results into files and directories.

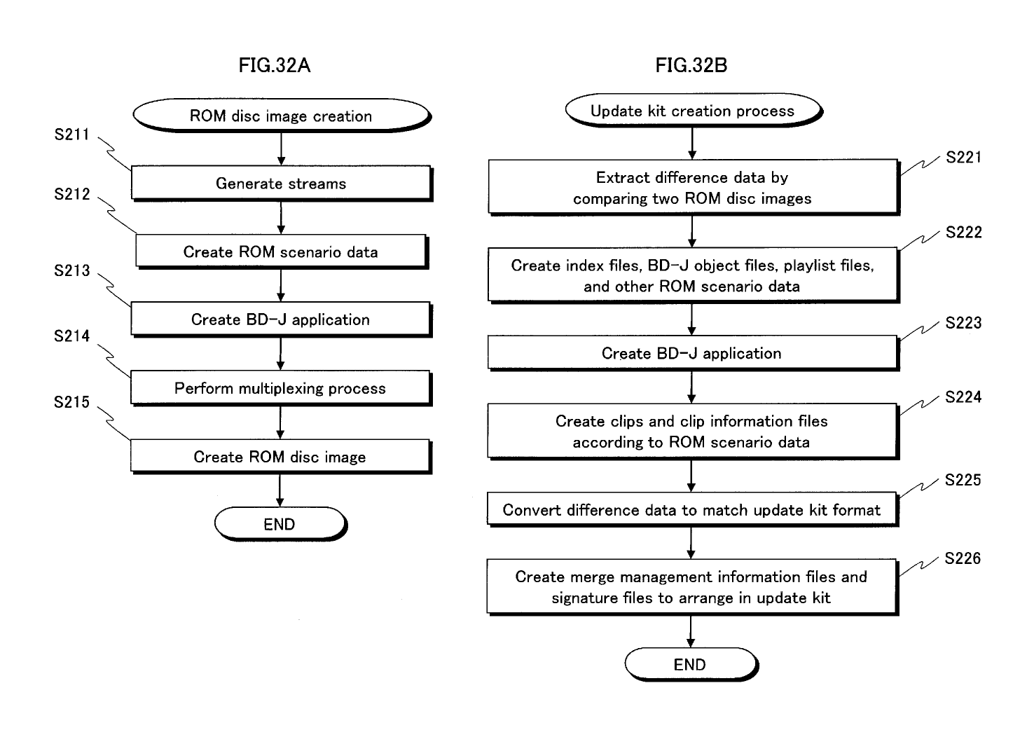

FIG. 32A is a flowchart showing the processing order for ROM disc image creation. FIG. 32B is a flowchart showing the processing order for update kit image creation.

In step S211, the material producer 601 generates video streams, audio streams, IG streams, and PG streams.

In step S212, the scenario generator 602 creates ROM scenario data describing playback scenarios. These include index files, movie object files, and playlist files.

In step S213, the BD-J producer 603 creates a BD-J application program.

In step S214, the multiplexer 604 creates audiovisual clips and clip information files according to the ROM scenario data.

In step S215, the formatter 605 rearranges the ROM scenario data, the various clips, the clip information files, and the restored bytecode data into the file and directory structure described for previous Embodiments, thus creating the ROM disc image.

In step S221, the difference extractor 606 compares the two disc images and extracts difference data therefrom.

In step S222, the update kit producer 607 creates ROM scenario data describing playback scenarios. These include index files, movie object files, and playlist files.

In step S223, the BD-J producer 603 creates a BD-J application program.

In step S224, the multiplexer 604 creates audiovisual clips and clip information files according to the ROM scenario data.

In step S225, the formatter 605 converts the difference data to match the update kit data format.

In step S226, merge management information files and signature information files are created and arranged in the update kit.

### (Supplement)

The following describes the details of audiovisual clips (“XXX.M2TS”), clip information files (“XXX.CLPI”), playlist information files (“XXX.MPLS”) and of the system target decoder 104.

(Internal Configuration of Audiovisual Clips)

Audiovisual clips are digital streams in the MPEG-2 transport stream format.

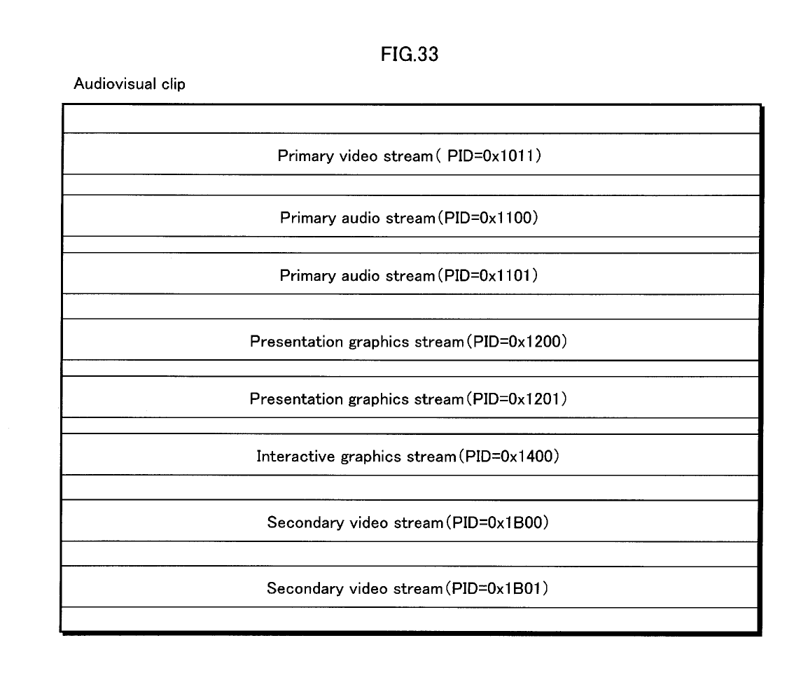

FIG. 33 shows an example of audiovisual clip structure. As shown, an audiovisual clip is obtained by multiplexing one or more video streams, audio streams, presentation graphics streams (PG), and interactive graphics streams. Video streams indicate the primary and secondary videos, audio streams indicate the primary audio track and the secondary audio track mixed with the primary track, and presentation graphics streams indicate subtitles for the movie. The primary video is the video that is normally displayed on the screen, while the secondary video is displayed in a smaller window within the primary video. Interactive graphics streams are GUI elements arranged on the screen create an interactive display. Each stream included in an audiovisual clip is identified by a PID. For example, the PIDs assigned to the streams used in the movie are 0x1011 for the primary video stream, 0x1100 through 0x111F for the primary audio stream, 0x1200 through 0x121F for the presentation graphics streams, 0x1400 through 0x141F for the interactive graphics streams, 0x1B00 through 0x1B1F for the secondary video streams, and 0x1A00 through 0x1A1F for the secondary audio streams.

(Audiovisual Clip Multiplexing)

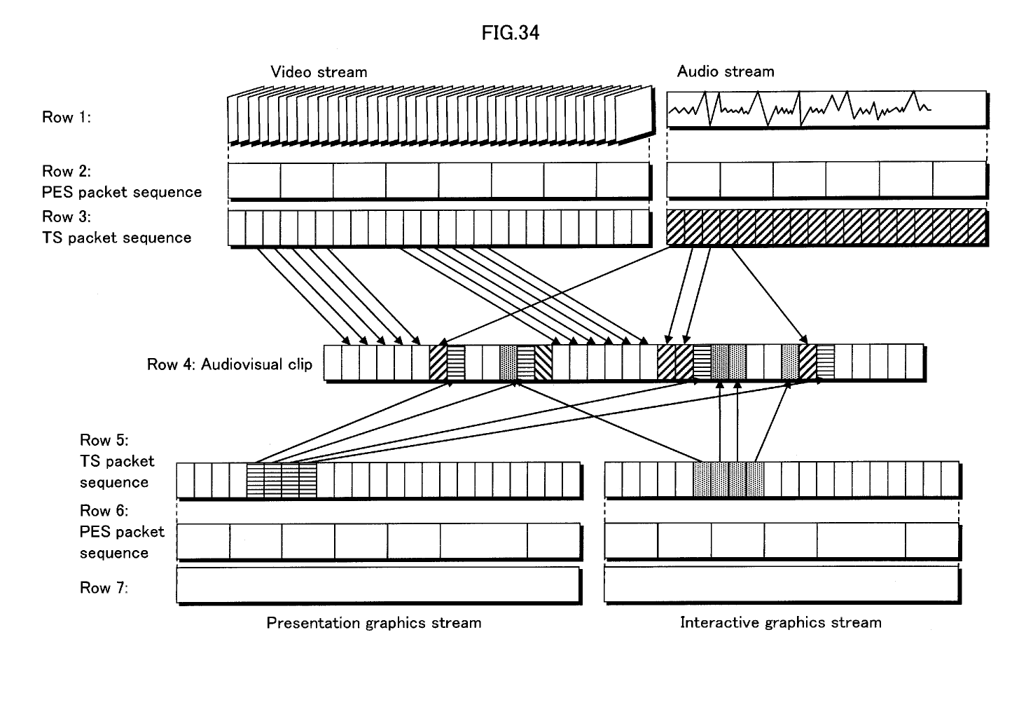

FIG. 34 is a schematic diagram illustrating audiovisual clip multiplexing. First, the video stream and audio stream (row 1) are converted into respective PES packet sequences (row 2) which are, in turn, converted into TS packet sequences (row 3). Similarly, the presentation graphics stream and interactive graphics stream (row 7) are converted into respective PES packet sequences (elementary streams) (row 6), then further converted into TS packet sequences (row 5). The audiovisual clip (row 4) comprises all of these TS packets, multiplexed into a single stream.

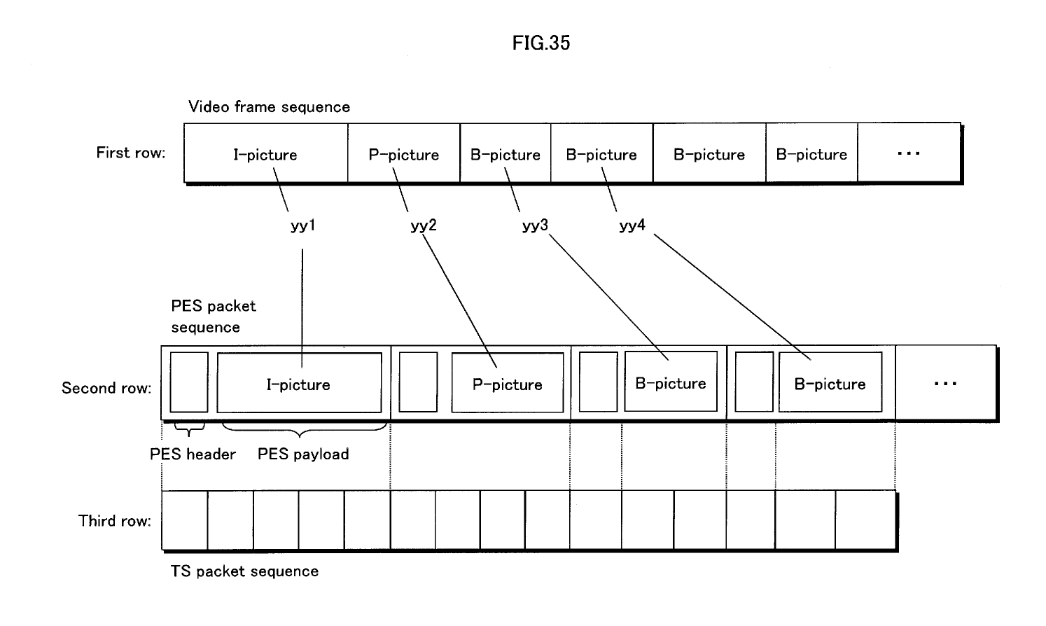

FIG. 35 illustrates the manner in which the video stream is contained within the PES packet stream. The first row shows a video frame sequence for the video stream. The second row shows the PES packet sequence. The third row shows the TS packet sequence obtained by converting the PES packet sequence. The arrows yy1, yy2, yy3, and yy4 point out how the video presentation units making up the video stream, namely I-pictures, B-pictures, and P-pictures, are divided up and stored as the payloads of the PES packets. Each of the PES packets has a PES header. The PES headers contain the PTS (Presentation Timestamp) and the DTS (Decoding Timestamp).

(TS Packet Sequences)

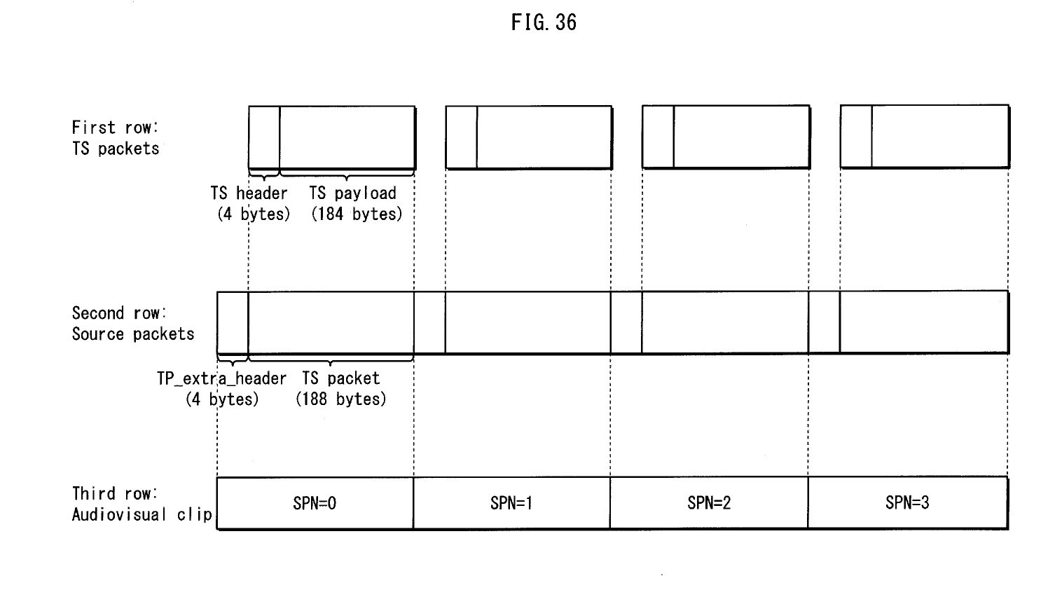

FIG. 36 shows the format of the TS packets as ultimately written into the audiovisual clips. The first row shows the TS packet sequence. The second row shows the source packet sequence. The third row shows the audiovisual clip.

As shown in the top row, the TS packets are fixed-length packets divided into a 4-byte TS header containing such information as the stream-identifying PID, and a 184-byte TS payload containing data. The above-described PES packets are split up and stored as TS payloads.

As shown in the second row, a 4-byte “TP_Extra_Header” is attached to the TS packets which are then converted into 192-byte source packets and written into the audiovisual clip. This “TP_Extra_Header” includes such information as the ATS (“Arrival_Time_Stamp”). The ATS indicates a timestamp at which TS packet transfer to the PID filter is to begin. As shown in the third row, the source packets are lined up in the audiovisual clip. The SPN (Source Packet Number) is incremented beginning at the start of the clip.

In addition to the video, audio, and subtitle streams, the TS packets included in the audiovisual clip also include a PAT (Program Association Table), a PMT (Program Map Table), a PCR (Program Clock Reference), and the like. The PAT indicates the PID of the PMT used within the clip, and the PID of the PAT itself is also registered. The PMT contains the PID of each video, audio, subtitle, and other stream included in the clip and property information for the stream corresponding to each PID, as well as various descriptors for the audiovisual clip. The descriptors are, for example, copy control information indicating whether or not the clip may be copied. The PCR contains STC information corresponding to the ATS at which the PCR packet is to be transferred to the decoder so that the ATC (Arrival Time Clock), which serves as the chronological axis for the ATS, can synchronize with the STC (system time clock), which serves as the chronological axis for the PTS and DTS.

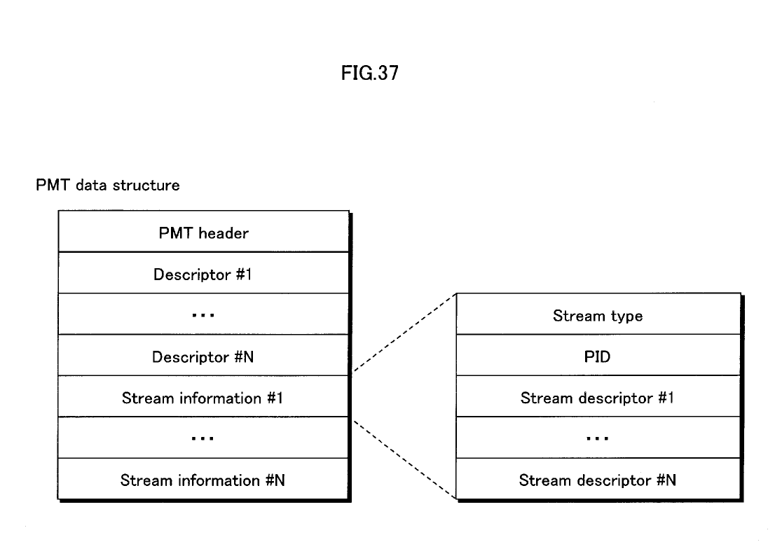

FIG. 37 is a data structure diagram of the PMT. The PMT header, which describes the length of the data contained in the PMT and so on, is arranged first. Next are found a set of descriptors pertaining to the audiovisual clip. The descriptors describe copy control information and the like, as mentioned above. After the descriptors come a set of stream information, #1 through #N, pertaining to the streams contained within the audiovisual clip. This stream information consists of the stream descriptors and describes the stream type so as to identify the compression codec and the like, the stream PID, and the stream properties (frame rate, aspect ratio, and so on). The number of stream descriptors is equal to the number of streams found in the audiovisual clip.

This concludes the explanation of the audiovisual clip. Next, the details of the clip information files are explained.

(Clip Information File)

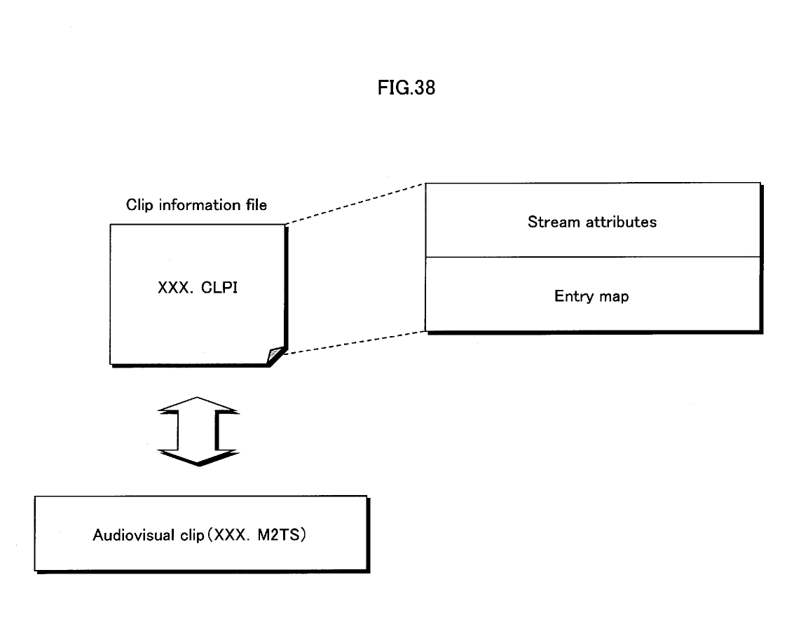

FIG. 38 shows an example of a clip information file. As shown, the clip information file is management information for the audiovisual clip consisting of stream properties and an entry map. There is a one-to-one relationship between the audiovisual clips and the clip information files.

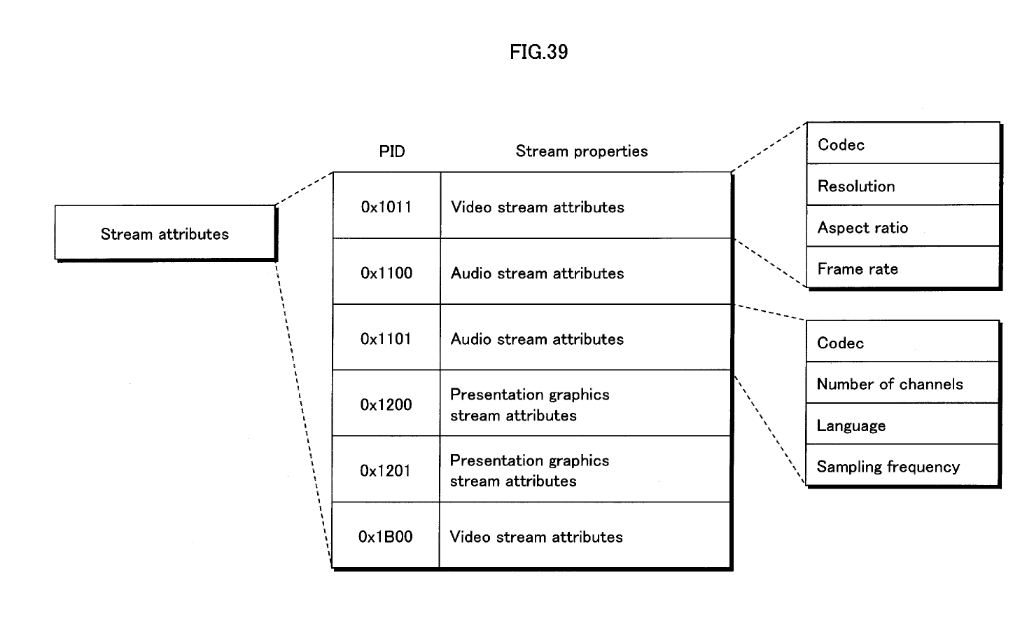

FIG. 39 shows an example of stream property information. As shown, the stream property information includes the stream properties of each stream included in the audiovisual clip, registered for each PID. The stream properties include different information for video streams, audio streams, presentation graphics streams, and interactive graphics streams.

Video stream properties include the codec with which the stream was compression coded, the individual resolutions of the pieces of picture data that make up the stream, the aspect ratio, the frame rate, and so on.

Audio stream properties include the codec with which the stream was compression coded, the number of channels included in the stream, the supported languages, the sampling frequency, and so on. These properties are used to initialize the decoder before playback by the playback device.

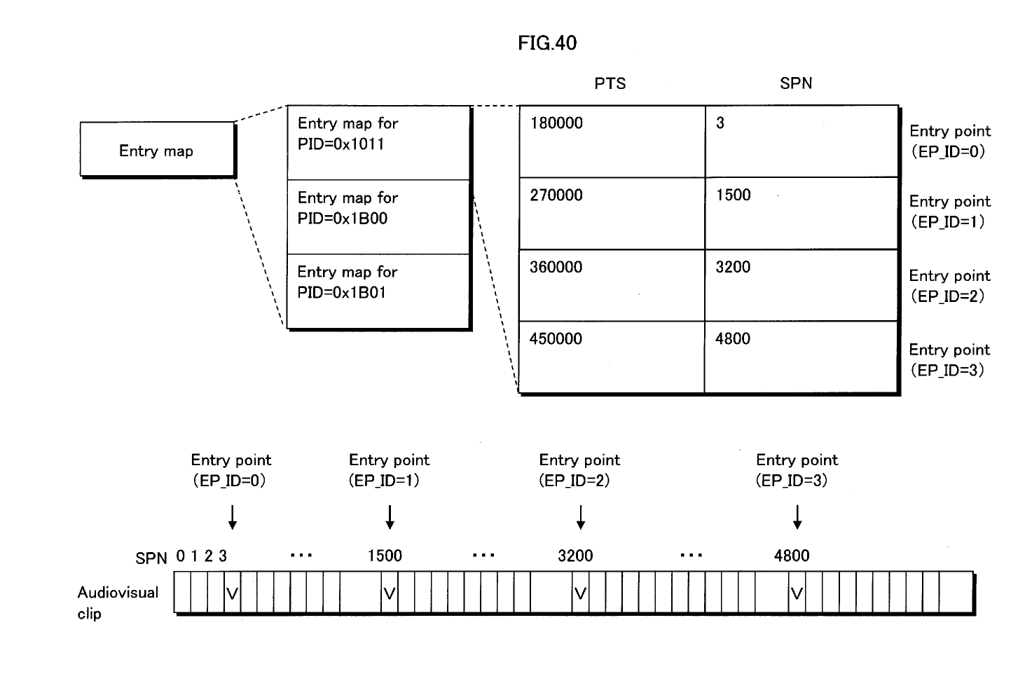

FIG. 40 shows an example of an entry map.

As shown, the entry map is an information table describing the PTS of the intra-coded frames (I-pictures) for each video stream included in the clip and the SPN of the clip starting with each I-picture.

The PTS and SPN shown in a single row of this table are jointly called an entry point. An incremental entry point ID (“EP ID”) is assigned to each entry point, beginning at 0. Using the entry map, the playback device is able to specify the file position of the audiovisual clip corresponding to any arbitrary point on the video stream chronological axis. For example, efficient processing can be performed with no need for clip analysis in trickplay modes, such as fast forward or rewind, by specifying, selecting, and playing back an I-picture registered in the entry map. An entry map is created for every video stream multiplexed within the audiovisual clip and managed using the PIDs. Chapter playback can be performed by assigning entry marks to the initial position of each chapter within a movie title.

This concludes the explanation of the clip information files. Next, the detailed data structure of the playlist information is described.

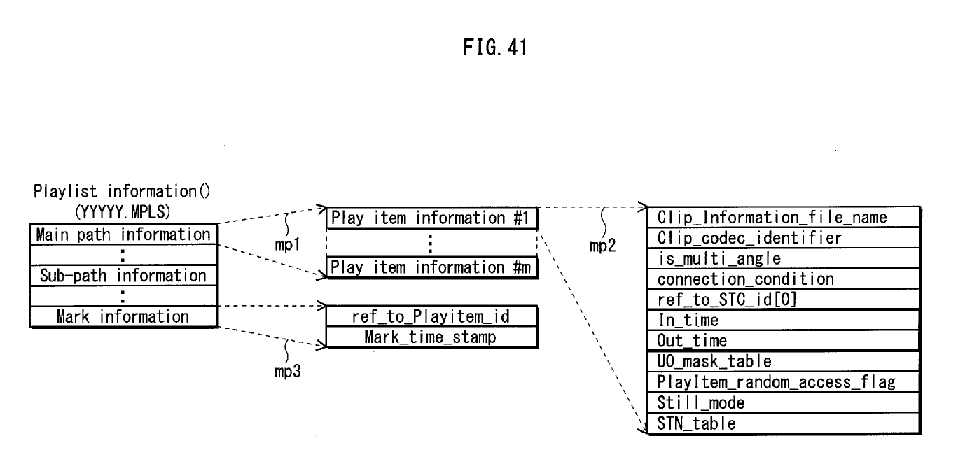

FIG. 41 shows the data structure of the playlist information. As shown, the playlist information includes main path information (MainPath( )) that defines the main path, sub-path information (Subpath( )) that defines the sub-paths, and mark information.

(Playlist Information Part 1: Main Path Information)

The following describes the main path information. The dotted line mp1 points to a close-up of the internal structure of the main path information. As shown by arrow mp1, the main path is defined by a plurality of pieces of play item information, #1 through #m. The pieces of play item information each define one logical playback unit making up the main path. A close-up of the structure of the play item information is pointed out by dotted line mp2. As shown, the play item information is made up of the following: a “Clip_Information_file_name” field showing the playback interval filename for the audiovisual clip belonging to a given playback interval defined by an In-point and Out-point, a “Clip_codec_identifier” field showing the encoding method for the clip, an “is_multi_angle” field indicating whether or not the play item comprises multiple angles, a “connection_condition” field showing the connection status between the current play item and the previous play item, a “ref_to_STC_id[0]” field indicating a unique “STC_Sequence” that is the target of the play item, an “In_time” field indicating the start time information for the playback interval, an “Out_time” field indicating the end time information for the playback interval, a “UO_mask_table” field indicating the user operations to be masked for the play item, a “PlayItem_random_access_flag” showing whether or not random access is permitted for the play item, a “Still_mode” field indicating whether the final picture is to remain displayed as a still image after playback of the play item has ended, and an “STN_table”. The playback path is made up of a combination of the “In Time” and the “Out_time”, and the playback path information is made of the “In_time” and “Out_time” fields.

(Playlist Information Part 2: Mark Information)

The following describes the mark information. The mark information (PLmark( )) designates an arbitrary segment along the chronological axis of a playlist as a chapter. The dotted line mp3 points out a close-up of the internal structure of the mark information. As shown by arrow mp3, the mark information is defined by a “ref_to_PlayItem_Id” field that indicates a play item and a “Mark_time_stamp” that indicates a point along the chronological axis of the playlist. Chapters are defined along the chronological axis by these indications.

(Playlist Information Part 3: Sub-Path Information)

In contrast to the main path, which is a playback path defined by the main clips of the primary video, the sub-paths are playback paths defined by sub-clips that must be synchronized with the main path.

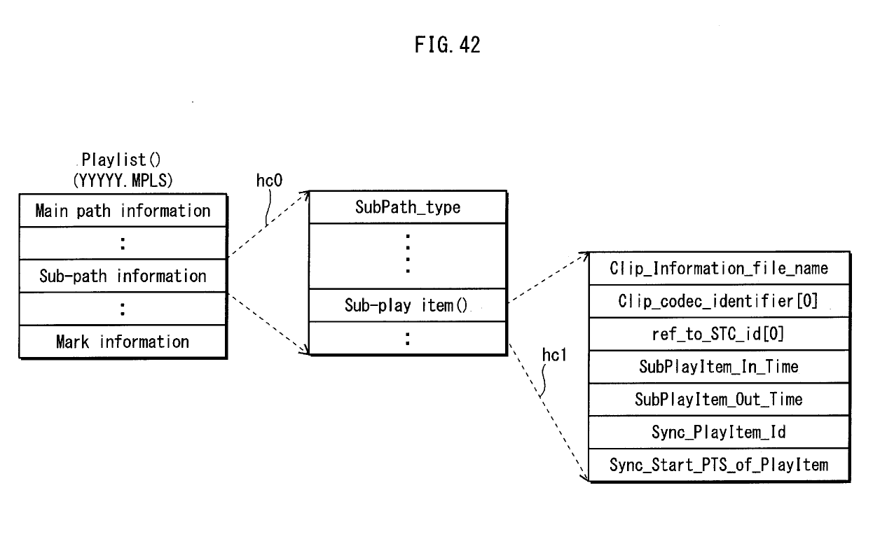

FIG. 42 shows the internal structure of the sub-path information. As shown by arrow hc0, each sub-path includes a “SubPath_type” field indicating the type of the sub-path, and one or more pieces of sub-play item information (“SubPlayItem( )”).

The dotted line hc1 points out a close-up of the sub-play item information structure.

A sub-play item branches off from the main path to define one or more elementary stream playback paths which are used to indicate the manner in which the path is to be synchronized with the main path. If a given sub-play item is used by a primary audio, presentation graphics, interactive graphics, secondary audio, or secondary video sub-path, then the sub-play item will be synchronized with the play item in the playlist used by the main path. The elementary streams used by the sub-paths for playback are distinct from the main clips used for play item playback in the main path. That is, the elementary streams are multiplexed into sub-clips.

The following describes the internal structure of the sub-play items. As indicated by arrow hc1, the sub-play item information is made up of the fields “Clip_information_file_name”, “Clip_codec_identifier”, “ref_to_STC_id[0]”, “SubPlayItem_In_time”, “SubPlayItem_Out_time”, “sync_PlayItem_Id”, and “sync_start_PTS_of_PlayItem”.

The “Clip_information_file_name” field indicates the sub-clip that corresponds to the sub-play item by listing the clip information file name.

The “Clip_codec_identifier” field shows the encoding method for the clip.

The “ref_to_STC_id[0]” field indicates a unique “STC_Sequence” that is the target of the play item.

The “SubPlayItem_In_time” indicates the start time for the sub-play item of the sub-clip along the playback chronological axis.

The “SubPlayItem_Out_time” indicates the end time for the sub-play item of the sub-clip along the playback chronological axis.

The “sync_PlayItem_Id” field uniquely indicates the play item making up the main path with which the sub-play item is to synchronize.

The “SubPlayItem_In_time” field is the time on the playback chronological axis at which the play item indicated by “sync_PlayItem_Id” is found.

The “sync_start_PTS_of_PlayItem” field indicates the position along the playback chronological axis of the play item indicated in “sync_PlayItem_Id” at which is found the sub-play item start time designated in “SubPlayItem_In_time”, to a temporal accuracy of 45 KHz. When a given sub-play item defines a playback interval within a secondary video stream and the “sync_start_PTS_of_PlayItem” field for that sub-play item indicates a point on the play item chronological axis, that sub-play item realizes a Synchronized Picture-In-Picture.

In addition, the “sync_start_PTS_of_PlayItem” field can be set to the undefined value (0xFFFF). This undefined value signifies that the time at which the user performs a locking operation along chronological axis of the play item designated in “sync_PlayItem_Id” is to serve as the play item synchronization point. If the “sync_start_PTS_of_PlayItem” field is set to the undefined value and the sub-play item is intended to play back a secondary video stream, then the sub-play item is used to realize Asynchronous Picture-in-Picture playback.

This concludes the description of the sub-path information.

(Playlist Information Part 5: STN_Table)

The “STN_Table” is characteristic of the playlist information.

The STN table indicates which of the multiple elementary streams multiplexed into the audiovisual clips designated by “Clip_Information_file_name” fields in the play item information and “Out_of_MUX” streams designated by “Clip_Information_file_name” fields in the sub-play item information can be played back. Specifically, the STN table is made up of a “Stream_entry” field for each of the “In_MUX” streams multiplexed in the main clips and the “Out_of_MUX” streams multiplexed into the sub-clips, and a corresponding “Stream_attribute” field.

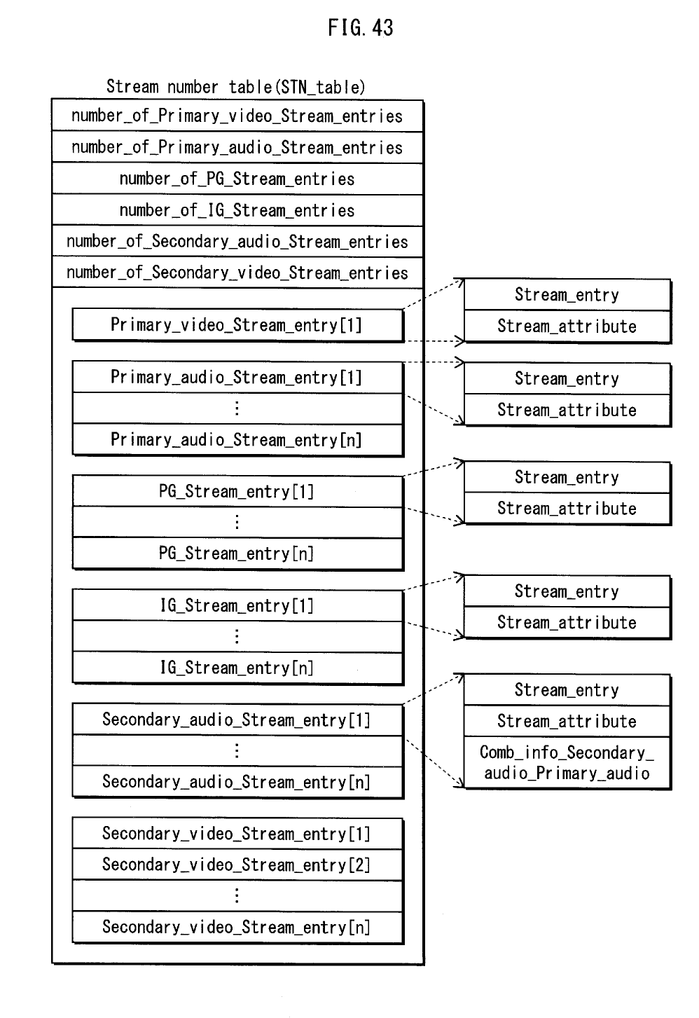

FIG. 43 shows an example of the overall configuration of the STN table. As shown, the STN table includes a single pair of a “stream_entry” and a “stream_attribute” for the primary video stream, and several pairs each made up of a “stream_entry” and a “stream_attribute” for each of several primary audio streams, PG streams, IG streams, secondary audio streams, and secondary video streams.

The STN table also includes a “number_of_video_stream_entries” field indicating the number of primary video streams that can be played back, a “number_of_audio_stream_entries” field indicating the number of primary audio streams that can be played back, a “number_of_PG_stream_entries” field indicating the number of PG streams that can be played back, a “number_of_IG_stream_entries” field indicating the number of IG streams that can be played back, a “number_of_Secondary_audio_stream_entries” field indicating the number of secondary audio streams that can be played back, and a “number_of_Secondary_video_stream_entries” field indicating the number of secondary video streams that can be played back.

### (System Target Decoder 104)

The details of the system target decoder 104 are described below.

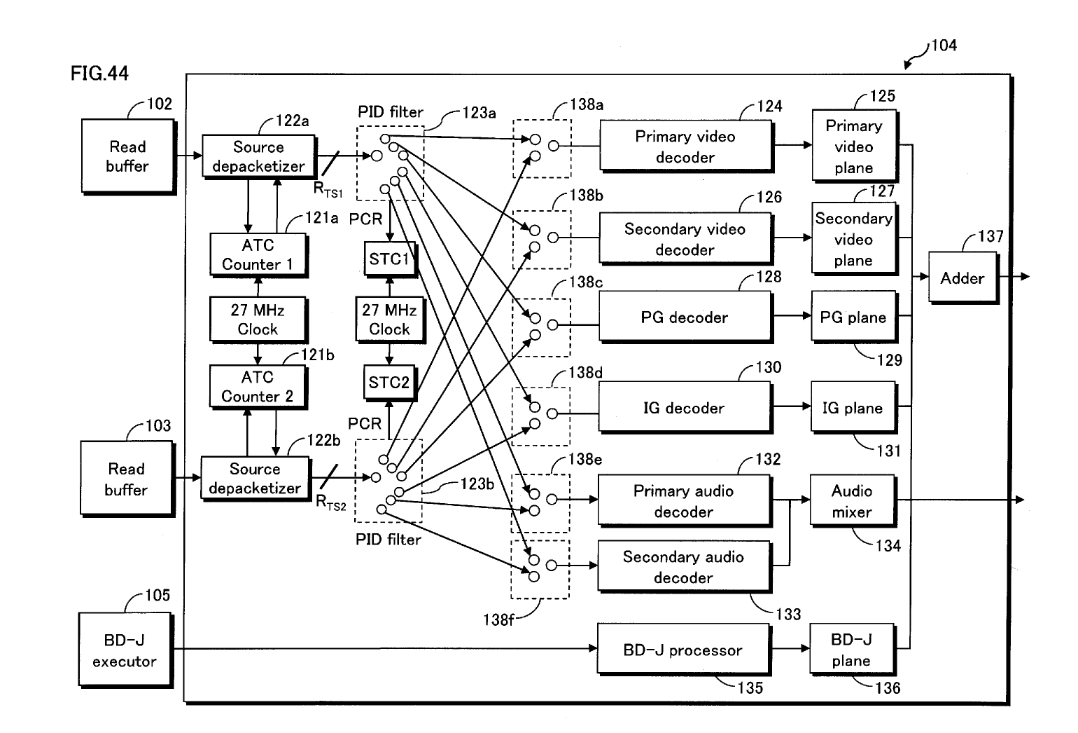

FIG. 44 shows an example of the internal configuration of the system target decoder 104. As shown, the system target decoder 104 comprises source depacketizers 122a and b, PID filters 123a and b, a primary video decoder 124, a primary video plane 125, a secondary video decoder 126, a secondary video plane 127, a PG decoder 128, a PG plane 129, an IG decoder 130, an IG plane 131, a primary audio decoder 132, a secondary audio decoder 133, an audio mixer 134, a BD-J processor 135, a BD-J plane 136, and an adder 137.

The source depacketizers 122a and b analyze the source packets transferred to the system target decoder 104 and extract the TS packets therefrom for transfer to the PID filters. At transfer time, the source packets are arranged according to ATS. Specifically, when the ATC value generated by the ATC counter and the ATS value of a source packet come to match, only that specific TS packet is transferred to the PID filter in accordance with the recording rate of the audiovisual clip.

The PID filters 123a and b transfer the TS packets output from the source depacketizers to the decoder needed for playback according to PID of the TS packets. The decoder may be the primary video decoder, the secondary video decoder, the IG decoder, the PG decoder, the primary audio decoder, or the secondary audio decoder. For the example of a BD-ROM, the packet is transferred to the primary video decoder 124 if the PID included in the TS packet is 0x1011, to the secondary video decoder 126 if the PID is between 0x1B00 and 0x1B1F, to the primary audio decoder 132 if the PID is between 0x1100 and 0x111F, to the secondary audio decoder 133 if the PID is between 0x1A00 and 0x1A1F, to the PG decoder 128 if the PID is between 0x1200 and 0x121F, and to the IG decoder 130 if the TS packet is between 0x1400 and 0x141F.

As shown in FIG. 44, there are two source depacketizers and two PID filters. One pair processes audiovisual clips transferred from read buffer 102 and the other pair processes audiovisual clips transferred from read buffer 103. If the sub-paths are synchronous, then the clips referenced by the main path and the clips referenced by the sub-path are played back synchronously. If the sub-paths are asynchronous, then the clips referenced by the main path and the clips referenced by the sub-path are played back asynchronously.

The primary video decoder 124 has a buffer in which to store data while extracting encoded pictures (I-pictures, B-pictures, and P-pictures) therefrom, with the exception of the TS headers, PES headers, and the like. The primary video decoder 124 creates multiple frames by decoding the DTS of each frame making up the video stream and writes the frames so created to the primary video plane 125 in accordance with the PTS. Given that the video streams multiplexed into the audiovisual clips are streams encoded using standards such as MPEG2, MPEG4-AVC, and VC1, the decoding method can be changed depending on the stream properties.

The primary video plane 125 stores therein the frames obtained by the primary video decoder 124.

The secondary video decoder 126, which has the same structure as the primary video decoder 124, decodes the secondary video streams input thereto and writes pictures to the secondary video plane in accordance with the PTS.

The secondary video plane 127 stores therein the frames obtained by the secondary video decoder 126.

The PG decoder 128 extracts and decodes the presentation graphics from the TS packets input from the source depacketizer and writes uncompressed graphical data to the PG plane in accordance with the PTS.

The PG plane 129 stores therein the uncompressed graphical data.

The IG decoder 130 extracts and decodes the interactive graphics from the TS packets input from the source depacketizer and writes uncompressed graphical data to the IG plane in accordance with the PTS.

The IG plane 131 stores therein the uncompressed graphical data.

The primary audio decoder 132 has a buffer in which to store data while performing an audio stream decoding process therewith, with the exception of the TS headers, PES headers, and similar data. The primary audio decoder 132 thus obtains uncompressed LPCM audio data to output to the audio mixer 134 in accordance with the PTS. Given that the audio streams multiplexed into the audiovisual clips are streams encoded in such formats as AC3 and DTS, the decoding method can be changed depending on the stream properties.

The secondary audio decoder 133, which has the same structure as the primary audio decoder, decodes the secondary audio streams input thereto and outputs uncompressed LPCM audio data to the audio mixer 134 in accordance with the DTS. Given that the audio streams multiplexed into the audiovisual clips are streams encoded in such formats as Dolby Digital Plus and DTS-HD LBR, the decoding method can be changed depending on the stream properties.

The audio mixer 134 mixes the uncompressed audio data output from the primary audio decoder and from the secondary audio decoder, and then outputs the result to the speakers.

The BD-J processor 135 decodes graphical data in the PNG and JPEG formats transferred from the BD-J executor 105 and outputs the result to the BD-J plane 129 as instructed by the BD-J application according to the PTS.

The BD-J plane 136 stores therein the graphical data decoded by the BD-J processor 135.

The adder 137 instantaneously overlays the data written in the primary video plane, the secondary video plane, the IG plane, the PG plane, and the BD-J plane, then outputs the result to a television or the like for display.

As described above, playlist playback can be realized through an internal structure conforming to the BD-ROM player model.

### (Virtual Package Construction)

The following describes the details of virtual package construction.

Firstly, the BD-ROM data structure, which serves as the basic portion of the virtual package, will be explained.

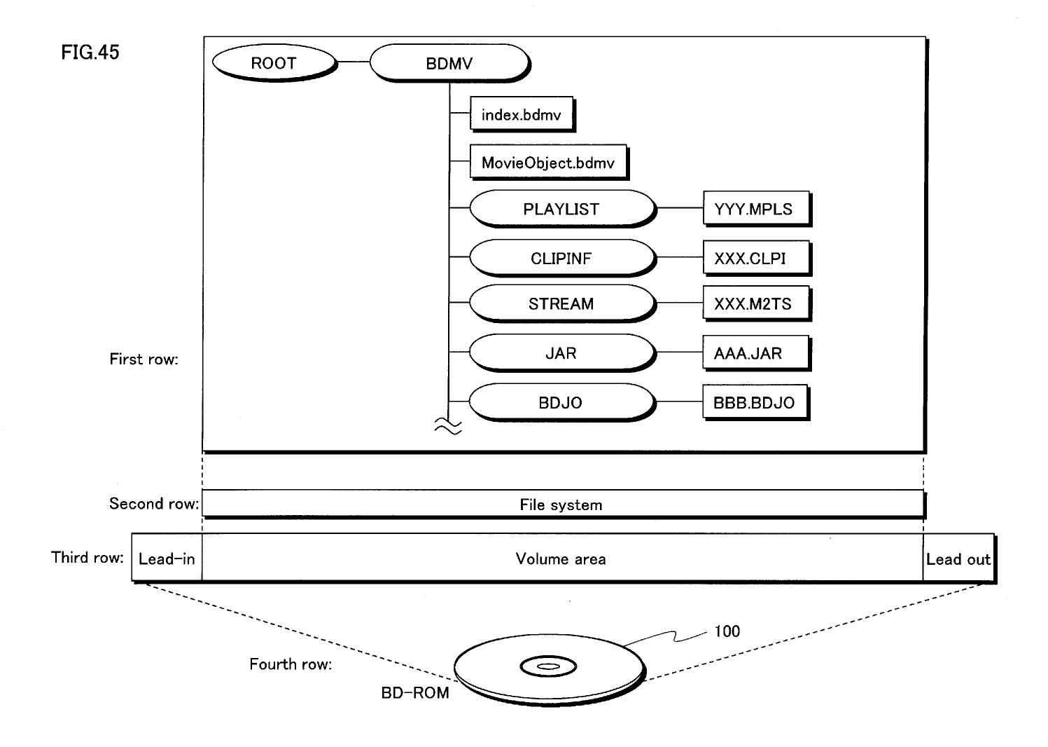

FIG. 45 shows an example of BD-ROM structure.

The fourth row shows a BD-ROM 100. The third row shows the tracks on the BD-ROM 100. The tracks are formed as spirals extending from the inner circumference to the outer circumference of the BD-ROM 100. Here, the tracks are drawn as if extended horizontally. Like other optical discs such as DVDs and CDs, the BD-ROM 100 has a spiral-shaped recording area extending from the inner circumference to the outer circumference. A logical address space for writing logical data is found between a lead-in at the inner circumference and a lead-out at the outer circumference. Also, a special area that can only be read by the drive, called a BCA (Burst Cutting Area), is found within the lead-in. This area, being inaccessible to applications, is used for copyright protection technologies and the like.

Volume information for the file system is recorded at the beginning of the logical address space, followed by application data such as video data. The BD-ROM 100 is recorded in UDF (Universal Disc Format) and is configured in a file system that comprises files and directories in which the data on the disc are arranged. Ordinary PCs (Personal Computers) also use a file system, such as FAT or NTFS. Data recorded on a hard disk in a file and directory structure can be displayed on a computer, and thus has high usability. The use a file system in which logical data is recorded in files and directories similar to those of a PC enables reading of the data.

The BD-ROM 100 has a ROOT directory, within which is found a BDMV directory. Data used by the BD-ROM 100, such as audiovisual content, management information, and the like, are recorded in the BDMV directory. Within the BDMV directory are found the following: an index file that defines an index table comprising the title (“index.bdmv”), a movie object file that defines a dynamic scenario (“MovieObject.bdmv”), a PLAYLIST directory, a CLIPINF directory, a STREAM directory, a BDJO directory, and JAR directory.

These directories contain audiovisual clips in which audiovisual content is multiplexed (“XXX.M2TS”), clip information files containing management information for the audiovisual clips (“XXX.CLPI”), and playlist files that define a logical playback path for the audiovisual clips (“YYY.MPLS”).

Other files are also present, as described below. Specifically, a BD-J object file that defines the JAR file to be executed and the execution method therefor (“BBB.BDJO”) and a JAR file that contains a BD-J application (“AAA.JAR”) are found. The above-listed files are respectively located in the STREAM directory, the CLIPINF directory, the PLAYLIST directory, the BDJO directory, and the JAR directory.

The data structure of the files located within the BDMV directory is explained below. First, the index file “index.bdmv” is described. The index file contains an index table.

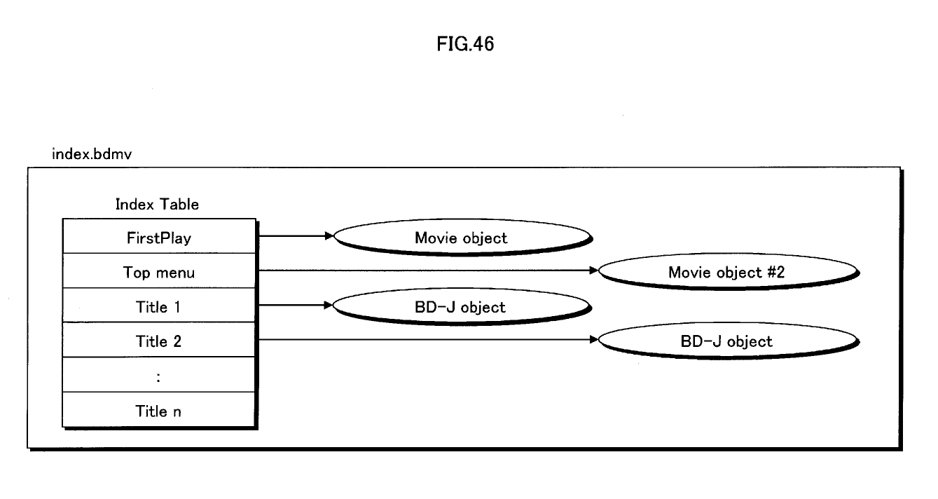

FIG. 46 shows an example of the internal structure of an index file.

The index table is a top-level table defining the title structure for all titles on the BD-ROM, the top menu, and the FirstPlay title. This table indicates a movie object that includes a movie object file initially executed from among all of the titles, the top menu, and the FirstPlay title. The BD-ROM playback device references the index table every time a title or menu is called in order to execute a pre-designated movie object or BD-J object. The FirstPlay title is set by the content provider so as to automatically execute a movie object or BD-J object when the disc is inserted. The top menu is a movie object or BD-J object designated for execution whenever a command such as “return to menu” is made through user operations of the remote control. Playlists to be played back with network attributes must be played back by the BD-J object.

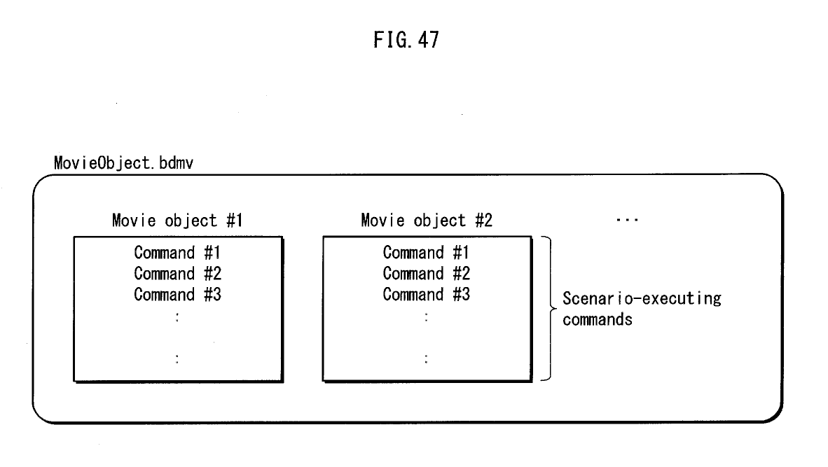

The movie object files are explained next. As shown in FIG. 47, a movie object file defines several movie objects, each of which is identified by a movie object ID. Each movie object has one or more navigation commands, these being playlist playback instructions or instructions to move to another movie object or title. The playback device executes this sequence of navigation commands. For example, if a command reads “PlayPL#N”, the playback device selects and plays back the playlist in the PLAYLIST directory with the corresponding file name.

Also, if a command reads “JumpObject#N”, the playback device selects and executes the corresponding movie object within the movie object file.

This concludes the description of the BD-ROM data structure needed to explain the virtual package.

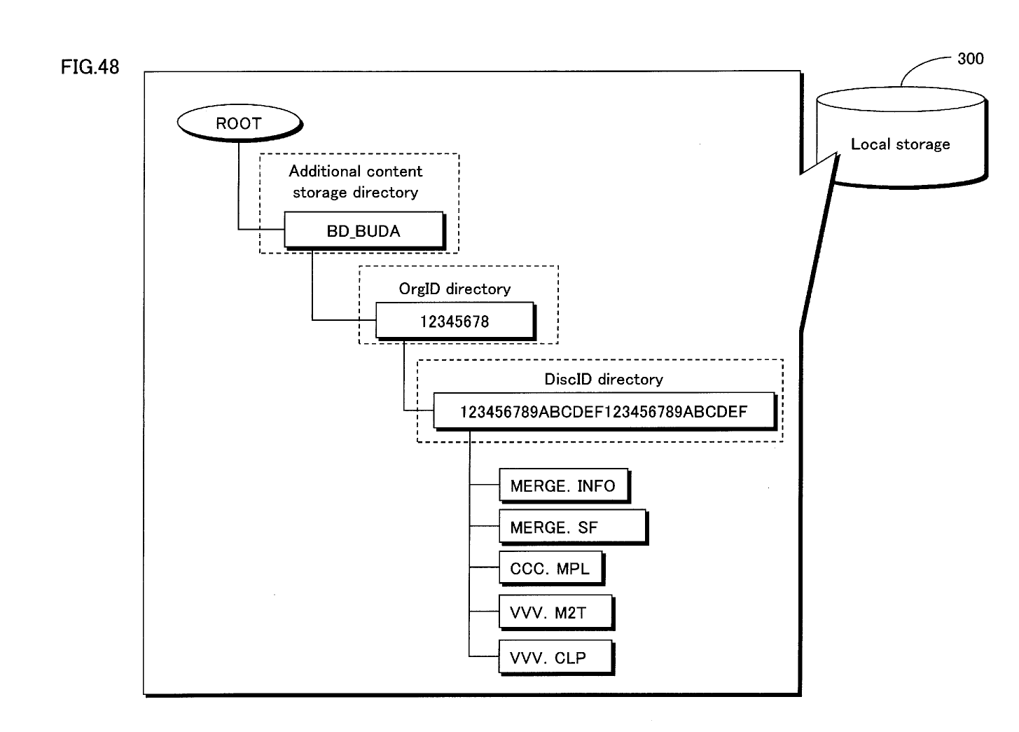

The following describes the data structure of the update kit stored in local storage 300 with reference to FIG. 48.

FIG. 48 shows an example of the internal structure of the update kit stored in the local storage 300.

As shown, the update kit stored in the local storage 300 includes an additional content storage directory, an OrgID directory, a DiscID directory, a merge management information file (“MERGE.INFO”), a signature information file (“MERGE.SF”), and additional content data files (“CCC.MPL”, “VVV.M2T”, “VVV.CLP” and so on).

The additional content storage directory is directly under the ROOT directory of local storage 300 and serves as the root directory for the additional content area. The directory name is a fixed value within the distribution medium characters (“BD_BUDA”).

The OrgID directory has a 32-bit identifier specifying the movie content provider (“OrganizationID”) as written in the BD management information (index file) for the BD-ROM recording layer, and an 8-character name. Leading zeroes in the “OrganizationID” are omitted from the directory name. For example, if the “OrganizationID” is “0x0000001A”, the directory name is simply “1A”.

The DiscID directory has a 128-bit identifier specifying the BD-ROM recording layer (“DiscID”) as written in the BD management information (index file) for the BD-ROM recording layer, divided into four 32-bit segments each having a 16-character name. Much like the OrganizationID, leading zeroes in the DiscID are omitted from the directory name.

The merge management information file, the signature information file, and the additional content files are located in the DiscID directory.

The merge management information file (“MERGE.INFO”) is stored in the DiscID directory and indicates file location information for each file recorded in local storage and needed to construct the virtual package, together with the virtual path needed to access each file within the virtual package.

The signature information file shows the electronic signature of the provider for the merge management information and is stored in the DiscID directory with the name “MERGE.SF”. The electronic signature is used to calculate a hash value for information required for general tamper protection, the hash value being encrypted with some sort of private key. In the present Embodiment, the signature information file uses a private key that corresponds to a public key in the merge certificate on the BD-ROM recording layer to encrypt the hash value of the merge management information file.

The merge certificate is a certificate used to authenticate the merge management information file and includes a public key published by the provider. The merge certificate supplied by the provider is saved on the BD-ROM recording layer as the file “bd.cert”. The file type of the merge certificate may be X.509, for instance.

The additional content data files are a group of additional or updated files for the original content recorded on the BD-ROM recording layer. In this example, these files include playlist files and audiovisual clips.

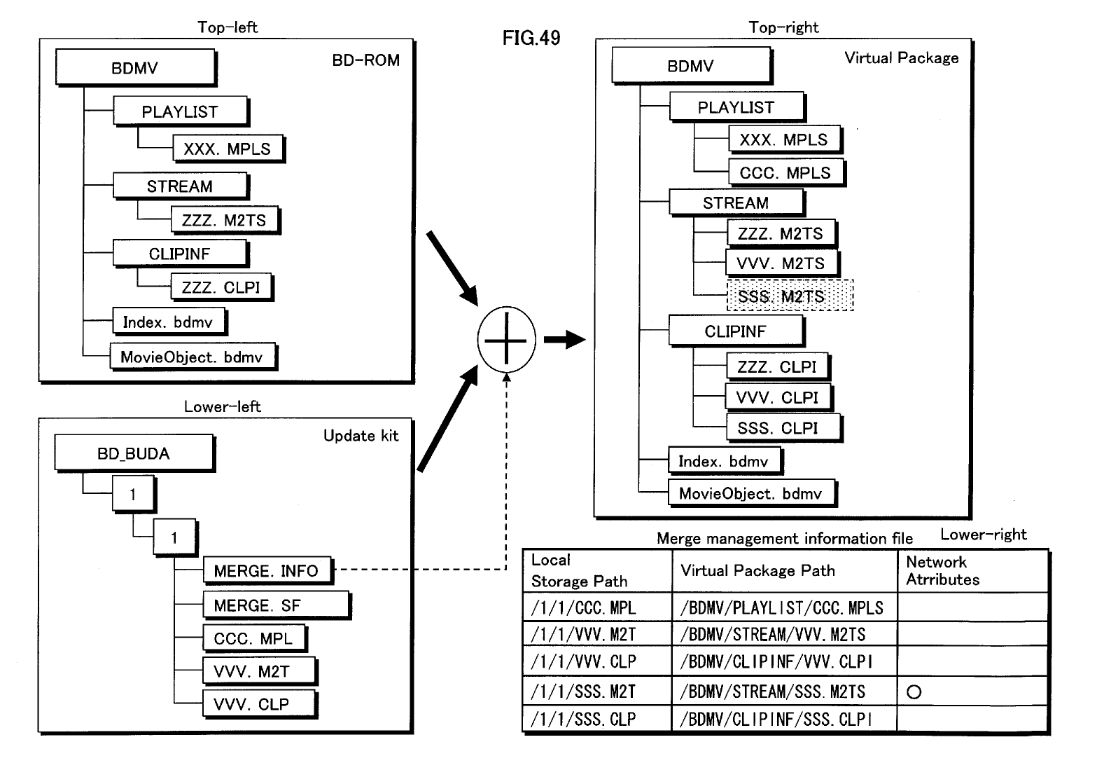

FIG. 49 shows an example of a virtual package constructed from the content of the merge management information file and the files on the BD-ROM and in the update kit, which are the basis of that content.

In FIG. 49, the upper-left corner shows the directory and file structure of the BD-ROM. The lower-left corner shows the directory and file structure of the update kit.

The lower-right corner shows the content of the merge management information file. The merge management information file comprises a local storage path column of paths pointing to the local storage, a virtual package path column of paths for accessing the same file from the virtual package, and a network attributes column. The network attributes column indicates whether or not virtual package construction may proceed without a given file.

The examples of local storage paths shown in FIG. 49 are “1/1/CCC.MPL”, “1/1/VVV.M2T”, “1/1/VVV.CLP”, “1/1/SSS.M2T”, and “1/1/SSS.CLP”. These indicate the path to the additional content data files from the “BD_BUDA” directory.

In contrast, the virtual package paths shown are “BDMV/PLAYLIST/CCC.MPLS”, “BDMV/STREAM/VVV.M2TS”, “BDMV/CLIPINF/VVV.CLPI”, “BDMV/STREAM/SSS.M2TS”, and “BDMV/CLIPINF/SSS.CLPI”.

The upper-right corner of FIG. 49 shows a virtual package generated from such a manifest file. The structure of the files and directories is modified such that the files saved at the local storage paths “1/1/CCC.MPL”, “1/1/VVV.M2T”, “1/1/VVV.CLP”, “1/1/SSS.M2T”, and “1/1/SSS.CLP” are respectively arranged at the paths “BDMV/PLAYLIST/CCC.MPLS”, “BDMV/STREAM/VVV.M2TS”, “BDMV/CLIPINF.VVV.CLPI”, “BDMV/STREAM/SSS.M2TS”, and “BDMV/CLIPINF/SSS.CLPI”. Accordingly, the files “CCC.MPLS”, “VVV.CLPI”, “VVV.M2TS”, “SSS.CLPI”, and “SSS.M2TS”, which are not on the BD-ROM, can be handled in the virtual package as if they were.

By generating the virtual package according to the merge management information, the files in the local storage can be accessed through path information listed therein. The file “SSS.M2TS”, which has network attributes, need not be fully downloaded into the local storage before virtual package construction. The file may be downloaded when needed, after virtual package construction.

Thus, the order in which files are written to the local storage when the update kit is download is as follows: first the merge management information file, then the playlist information, then the clip information, and finally the audiovisual clips. Virtual package construction can therefore begin as soon as the playlist information and the clip information are fully downloaded. The audiovisual clips can simply be treated as though they were in the Disabled state.

According to the above, sub-play items can be supplied to the system target decoder through a virtual file system.

(Combination with BD-ROM)

When the main path indicates a feature film stored on the disc, the audiovisual clips with stream numbers corresponding to the sub-play items used from the current playback position onward, namely:

the current primary audio stream number SPRM (1),

the subtitle stream number SPRM (2),

the secondary video stream number SPRM (21),

and the secondary audio stream number SPRM (22)

are preferably sequentially downloaded according to a schedule that closely reflects the playback order, beginning at the current playback position.

Accordingly, given that users rarely change the subtitle and audio track while viewing the main feature, playlist playback can be realized without forcing the user to wait.

### (Supplement)

The present invention is, naturally, not limited to the above-described Embodiments.

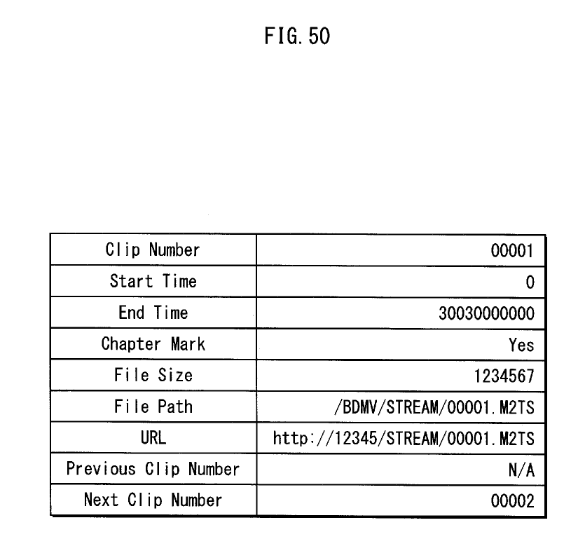

(1) In the above Embodiments, the network playback information comprises clip numbers, start time information indicating the starting point of the playback interval for each play item, end time information indicating the ending point of the playback interval for each play item, chapter mark information, and file sizes. However, as shown in FIG. 50, this information can be supplemented with URL information indicating the address at which the update kit can be obtained by the BD-J application via the network, file paths at which the audiovisual clips are stored in the local storage, mark information indicating breaking points for commercials and the like within the clips, and information indicating the clip number of the clip that precedes or follows a given clip.
(2) In the above Embodiments, a playback resumption control process is performed when resuming playback after pausing. However, such a process is not always necessary. Playback can also resume as soon as the audiovisual clip corresponding to the subsequent play item to be played back comes to be in the Enabled state.
(3) In the above Embodiments, the BD-J application specifies the playback direction by obtaining the playback speed from the PSR set. However, if the system is configured such that playlists are played back sequentially, the playback speed need not necessarily be obtained.
(4) In the above Embodiments, the BD-J application issues an instruction to pause the playback of the current audiovisual clip when the subsequent clip to be played back is not in a playable state. However, the present invention is not limited in this manner. The display time of the current clip may instead by extended, such as through slow-motion playback. Also, graphics notifying the viewer that clip download is in progress may be superposed on the audiovisual clip when playback is paused or slowed.
(5) In the above Embodiments, when the subsequent audiovisual clip to be played back is not in a playable state, controls are performed such that the clip currently being played back is paused without allowing playback to reach the end of the clip. However, playback may instead proceed to the end of the current clip such that the final frame thereof is paused. Alternatively, a substitute video may be played back after the end of the current clip is reached.
(6) In the above Embodiments, the playback control engine 111 is mainly described as playing back the play items sequentially from the start of the playlist. However, the present invention also applies to playback involving such actions as skipping chapters. Specifically, the skip destination playback location is set as the playback position, and playback is paused if the audiovisual clip that follows the audiovisual clip that includes the playback position is not in a playable state.
(7) As shown in FIG. 11, a playlist playback instruction is made when all of the audiovisual clips not yet fully downloaded satisfy the relation of (Math. 1). However, a playlist playback instruction may also be made when a predetermined number of clips satisfy the relation of (Math. 1). For example, a playlist playback instruction can be made when audiovisual clips #3 through #7 in FIG. 11 satisfy the relation of (Math. 1), while no such instruction is made if even one of the clips does not satisfy (Math. 1).

Accordingly, audiovisual clip pausing can be avoided to the greatest extent possible without unduly delaying the playback start time.

(8) In the above Embodiments, as shown in FIG. 2, the playlist comprises a main path and one or more sub-paths. However, the playlist may also comprise a main path only, without any sub-paths.

The above-described Embodiments and Supplements may be freely combined.

### INDUSTRIAL APPLICABILITY

The present invention is widely applicable to playback devices operable to perform streaming-like playback.

### REFERENCE SIGNS LIST

100 playback device
101 BD-ROM drive
102, 103 read buffers
104 system target decoder
105 BD-J executor
106 network interface
107 virtual package controller
108 state manager
109 user event processor
110 playback engine
111 playback control engine
112 HDMI transceiver
113 heap memory
114 virtual machine interpreter
115 PSR set
200 BD-ROM
300 local storage
400 web server
500 television

1. A playback device for playing back a plurality of digital streams constituting a stream sequence while sequentially downloading the digital streams from an external resource as requested by an application, comprising:
an execution unit operable to execute the application corresponding to the stream sequence;
a time information storage unit that stores therein time information indicating a current playback time for the stream sequence;
a state information storage unit that stores therein state information indicating whether each of the digital streams is in a playable state or in a non-playable state; and
a playback control unit operable to control playback of the stream sequence, wherein
the application:
includes playback interval information indicating a playback start time and a playback end time for each of the digital streams; and
specifies a subsequent digital stream to be played back after the digital stream currently being played back according to the time information stored in the time information storage unit and the playback interval information, and
when the state information stored in the state information storage unit indicates the non-playable state for the subsequent digital stream, the playback control unit performs, as requested by the application, one of a trickplay operation for extending a display duration of the digital stream currently being played back and playback of a substitute video as a replacement for the subsequent digital stream.

2. The playback device of claim 1, further comprising a playback speed storage unit that stores therein a value indicating a playback speed for the stream sequence, wherein
the application specifies a playback direction for the stream sequence according to whether the value indicating the playback speed is positive or negative, and
the subsequent digital stream is specified with further reference to the playback direction.

3. The playback device of claim 2, further comprising a download unit operable to sequentially download the digital streams from the external resource, wherein
the state information for the subsequent digital stream is stored in the state information storage unit as non-playable when the subsequent digital stream has not yet been downloaded, and
the download unit prioritarily downloads the subsequent digital stream as requested by the application.

4. The playback device of claim 3, wherein
when the value indicating the playback speed is negative, the application specifies the playback direction for the stream sequence as being reverse-chronological, and
the subsequent digital stream corresponds to a playback interval that immediately precedes a playback interval corresponding to the digital stream currently being played back.

5. The playback device of claim 3, wherein
the stream sequence is played back according to a playlist,
the playlist includes a plurality of play items,
the play items are in one-to-one correspondence with the digital streams, each indicating a playback interval for the corresponding digital stream,
a subset of the play items feature a chapter mark, and
the application further includes chapter mark information indicating the subset of the play items that features the chapter mark, and specifies the digital stream corresponding to a chapter mark-featuring play item nearest to the digital stream currently being played back as the subsequent digital stream according to the chapter mark information.

6. The playback device of claim 5, wherein
the download unit prioritarily downloads digital streams not yet downloaded corresponding to chapter mark-featuring play items, as requested by the application.

7. The playback device of claim 5, wherein
the digital streams corresponding to the chapter mark-featuring play items are smaller in size than non-chapter-mark-featuring digital streams.

8. The playback device of claim 1, wherein
the state information indicates that the digital stream corresponding to a playback start position for the stream sequence is in the playable state,
the application calculates (i) a playback duration from the playback start position through a digital stream immediately preceding a given digital stream not yet fully downloaded for which the state information indicates the non-playable state, and (ii) a total download time needed to download all of the digital streams from a leading digital stream up to and including the given digital stream, and
the playback control unit begins playback from the playback start position as requested by the application when the total download time is less than the playback time.

9. The playback device of claim 8, wherein
the application calculates the playback duration and the total download time for each of the digital streams not yet fully downloaded for which the state information indicates the non-playable state, and
the playback control unit begins playback when the total download time is less than the playback time, for all of the digital streams.

10. The playback device of claim 1, wherein
the playback device plays back a plurality of sub-stream sequences while downloading the sub-stream sequences from the external resource together with the stream sequence,
the stream sequence is a main clip,
each sub-stream sequence is a sub-clip comprising a plurality of sub-digital streams,
the sub-clips include at least one of subtitle streams and audio streams,
the state information further indicates whether each of the sub-digital streams is in the playable state or in the non-playable state, and
during playback of one of the sub-digital streams from a given sub-clip together with the main clip, the playback control unit causes playback to continue with a sub-digital stream from another sub-clip after playing back the given sub-digital stream as requested by the application when the state information of a subsequent sub-digital stream to be played back after the sub-digital stream indicates the non-playable state and the state information of the sub-digital stream from the other sub-clip indicates the playable state.

11. The playback device of claim 1, wherein
the playback device plays back a plurality of sub-stream sequences while downloading the sub-stream sequences from the external resource together with the stream sequence,
the stream sequence is a main clip,
each of the sub-stream sequences is a sub-clip comprising a plurality of sub-digital streams,
the sub-clips include at least one of subtitle streams and audio streams,
the state information further indicates whether each of the sub-digital streams is in the playable state or in the non-playable state, and
during playback of one of the sub-digital stream from a given sub-clip together with the main clip, the playback control unit performs the trickplay operation for extending the display duration of the digital stream and the sub-digital stream currently being played back, as requested by the application, when a user instruction is received to change from the given sub-clip to another sub-clip and the state information of the sub-digital stream to be played back from the other sub-clip indicates the non-playable state.

12. The playback device of claim 1, wherein
the trickplay operation is pausing.

13. The playback device of claim 1, wherein
the trickplay operation is slow playback.

14. The playback device of claim 12, further comprising a processor operable to render graphics as requested by the application, wherein
the graphics are displayed as overlaid on the digital stream undergoing the trickplay operation.

15. A playback method used by a playback device for playing back a plurality of digital streams constituting a stream sequence while sequentially downloading the digital streams from an external resource as requested by an application, comprising:
an execution step of executing the application corresponding to the stream sequence; and
a playback control step of controlling playback of the stream sequence, wherein
the application:
includes playback interval information indicating a playback start time and a playback end time for each of the digital streams, and
specifies a subsequent digital stream to be played back after the digital stream currently being played back according to (i) time information stored in the playback device and indicating a current playback time for the stream sequence and (ii) the playback interval information, and
when state information stored in the playback device and indicating whether each of the digital streams is in a playable state or in a non-playable state indicates the non-playable state for the subsequent digital stream, the playback control step consists of performing, as requested by the application, one of a trickplay operation for extending a display duration of the digital stream currently being played back and playback of a substitute video as a replacement for the subsequent digital stream.

16. A recording medium on which is recorded an application, wherein
the application is executed by a playback device for playing back a plurality of digital streams constituting a stream sequence while sequentially downloading the digital streams from an external resource as requested by the application, the playback device comprising:
an execution unit operable to execute the application corresponding to the stream sequence;
a time information storage unit that stores therein time information indicating a current playback time for the stream sequence;
a state information storage unit that stores therein state information indicating whether each of the digital streams is in a playable state or in a non-playable state; and
a playback control unit operable to control playback of the stream sequence, and
the application:
includes playback interval information indicating a playback start time and a playback end time for each of the digital streams,
performs a specification step of specifying a subsequent digital stream to be played back after the digital stream currently being played back according to the time information stored in the time information storage unit and the playback interval information, and
performs a requesting step of requesting that, when the state information stored in the state information storage unit indicates the non-playable state for the subsequent digital stream, one of a trickplay operation for extending a display duration of the digital stream currently being played back and playback of a substitute video as a replacement for the subsequent digital stream be performed by the playback control unit.

17. An application executed by a playback device for playing back a plurality of digital streams constituting a stream sequence while sequentially downloading the digital streams from an external resource, the playback device comprising:
a time information storage unit that stores therein time information indicating a current playback time for the stream sequence;
a state information storage unit that stores therein state information indicating whether each of the digital streams is in a playable state or in a non-playable state; and
a playback control unit operable to control playback of the stream sequence, wherein
the application:
includes playback interval information indicating a playback start time and a playback end time for each of the digital streams,
performs a specification step of specifying a subsequent digital stream to be played back after the digital stream currently being played back according to the time information stored in the time information storage unit and the playback interval information, and
performs a requesting step of requesting that, when the state information stored in the state information storage unit indicates the non-playable state for the subsequent digital stream, one of a trickplay operation for extending a display duration of the digital stream currently being played back and playback of a substitute video as a replacement for the subsequent digital stream be performed by the playback control unit.

18. An authoring device, comprising:
a reception unit operable to receive a user operations and
a generation unit operable to generate an application according to the user operation, wherein
the application includes playback interval information indicating a playback start time and a playback end time for each of a plurality of digital streams constituting a stream sequence, and
the application performs
an obtaining step of obtaining time information indicating a current playback time for the stream sequence from a playback device;
a specifying step of specifying a subsequent digital stream to be played back after the digital stream currently being played back by the playback device according to the time information and the playback interval information; and
a requesting step of requesting that, when the subsequent digital stream is not in a playable state, the playback device perform one of a trickplay operation for extending a display duration of the digital stream currently being played back and playback of a substitute video that replaces the subsequent digital stream.

19. The playback device of claim 6, wherein
the digital streams corresponding to the chapter mark-featuring play items are smaller in size than non-chapter-mark-featuring digital streams.

20. The playback device of claim 13, further comprising a processor operable to render graphics as requested by the application, wherein
the graphics are displayed as overlaid on the digital stream undergoing the trickplay operation.
